(19) United States
(12) Patent Application Publication
(10) Pub. No.: US 2025/0284994 A1
(43) Pub. Date: Sep. 11, 2025

(54) HIGH FIDELITY ROOM TEMPERATURE QUANTUM MEMORY

(71) Applicant: Qunnect, Inc., Brooklyn, NY (US)

(72) Inventors: Yang Wang, New York, NY (US); Alexander Craddock, Brooklyn, NY (US); Rourke Sekelsky, Brooklyn, NY (US); Mael Flament, Brooklyn, NY (US); Mehdi Namazi, Brooklyn, NY (US)

(73) Assignee: Qunnect, Inc., Brooklyn, NY (US)

(21) Appl. No.: 18/868,707

(22) PCT Filed: May 24, 2023
(86) PCT No.: PCT/US2023/023346

§ 371 Date: Nov. 22, 2024

Related U.S. Application Data
(60) Provisional application No. 63/345,189, filed on May 24, 2022.

(51) Int. Cl. G06N 10/40

(52) U.S. Cl. CPC G06N 10/40

(57) ABSTRACT

Provided herein are systems and methods for implementing a field-deployable quantum memory. The quantum memory device includes a device housing configured to be rack-mounted and a quantum memory module disposed within the device housing and configured to perform a memory operation including storing an input qubit and retrieving the stored qubit for output. The quantum memory device may also include a filter module disposed within the device housing and configured to filter an output of the quantum memory module.

### CROSS REFERENCE TO RELATED APPLICATIONS

This application claims the benefit under 35 U.S.C. § 119(e) to U.S. Provisional Application No. 63/345,189, filed May 24, 2022, under Attorney Docket No. Q0074.70009US00, titled “HIGH FIDELITY ROOM TEMPERATURE QUANTUM MEMORY,” which is incorporated herein by reference in its entirety.

### FEDERALLY SPONSORED RESEARCH

This invention was made with government support under DE0SC0019702 awarded by the Department of Energy. The government has certain rights in the invention.

### BACKGROUND

Quantum networks facilitate the transmission of information in the form of quantum bits (“qubits”) between physically separated quantum processors or other quantum devices (e.g., quantum sensors). Quantum networks may be used to enable optical quantum communication over distances and can be implemented over standard telecommunication optical fibers through the transmission of single photons onto which information is encoded (e.g., in polarization). To enable the reliable transmission of quantum information over any distances, additional components may be needed.

### SUMMARY

The following is a non-limiting summary of some embodiments of the present application. Some aspects of the present application are directed to a quantum memory device. The quantum memory device comprises: a housing; and a quantum memory module disposed in the housing and configured to store an input qubit, wherein: the housing is configured to be rack-mounted.

In some embodiments, the housing is configured to be rack-mounted in a server rack. In some embodiments, the housing is configured to be rack-mounted in a 19-inch rack.

In some embodiments, the housing comprises an acoustic and/or thermal barrier material lining interior surfaces of the housing.

In some embodiments, the housing comprises a first base plate configured to movably slide in a direction perpendicular to a front face of the housing, and the quantum memory module is disposed on the first base plate.

In some embodiments, the housing comprises a second base plate configured to movably slide in the direction perpendicular to the front face of the housing, a filter module is disposed on the second base plate, and the filter module is optically coupled to an output of the quantum memory module.

In some embodiments, the first base plate and/or the second base plate are mechanically decoupled from the housing. In some embodiments, the first base plate and/or the second base plate are suspended within the housing.

In some embodiments, the quantum memory module comprises an atomic vapor memory optically coupled to an input of the quantum memory module. In some embodiments, the atomic vapor memory comprises an atomic vapor cell and is configured to store the input qubit in an atomic vapor of the atomic vapor cell. In some embodiments, the atomic vapor comprises a rubidium vapor. In some embodiments, the atomic vapor comprises a vapor of ⁸⁷Rb.

In some embodiments, the atomic vapor memory comprises at least one heater, the at least one heater comprising: a bifilar resistive wire wound in a toroidal arrangement configured to generate approximately zero magnetic field at a center of the at least one heater. In some embodiments, the bifilar resistive wire wound in a toroidal arrangement and configured to generate approximately zero magnetic field outside of the toroidal arrangement.

In some embodiments, the bifilar resistive wire is wound around a base ring comprising a high-temperature plastic or a ceramic. In some embodiments, the high-temperature plastic comprises polyetherimide (PEI) and/or polyether ether ketone (PEEK). In some embodiments, the base ring comprises grooves on a surface of the base ring, the grooves being configured to maintain the bifilar resistive wire in the toroidal arrangement.

In some embodiments, the quantum memory module further comprises a magnetic shielding apparatus, the magnetic shielding apparatus being arranged to at least partially encapsulate the atomic vapor cell of the atomic vapor memory.

In some embodiments, the magnetic shielding apparatus comprises: a first magnetic shielding layer arranged to at least partially encapsulate the atomic vapor cell; and a second magnetic shielding layer arranged to at least partially encapsulate the second magnetic shielding layer.

In some embodiments, the atomic vapor cell, the first magnetic shielding layer, and the second magnetic shielding layer are each approximately cylindrical in shape, and the atomic vapor cell, the first magnetic shielding layer, and the second magnetic shielding layer are arranged concentrically about a same longitudinal axis.

In some embodiments, the at least one heater comprises a first heater and a second heater, the first heater is disposed at a first end of the atomic vapor cell, and the second heater is disposed at a second end of the atomic vapor cell opposing the first end, and the base rings of the first and second heaters are disposed in planes perpendicular to the longitudinal axis.

In some embodiments, the magnetic shield apparatus comprises an outer shell, the outer shell comprising: a first shell, the first shell comprising: a lower face; four side faces extending from the lower face; and an opening opposing the lower face, wherein: the first magnetic shielding layer is disposed within the first shell; and a second shell comprising: an upper face disposed over the opening in the first shell; and two side faces extending from the upper face and substantially covering two of the four side faces of the first shell.

In some embodiments, the first shell comprises a first material and the second shell comprises a second material different than the first material. In some embodiments, the first material comprises Ad-Mu-00 magnetic shielding alloy. In some embodiments, the second material comprises aluminum 6061.

In some embodiments, two of the four side faces of the first shell that are not substantially covered by the two side faces of the second shell each comprise an optical window disposed along the longitudinal axis.

In some embodiments, the second shell further comprises hold down features coupled to each of the two side faces of the second shell.

In some embodiments, the input qubit comprises quantum information encoded in an arbitrary polarization state of a photon, the quantum memory module further comprises a first optical component disposed between an input of the quantum memory module and the atomic vapor memory along an optical path of the quantum memory module, and the first optical component is configured to convert the input qubit into a spatial qubit propagating in a pair of parallel optical rails.

In some embodiments, the quantum memory module further comprises a second optical component disposed between an output of the atomic vapor memory and an output of the quantum memory module along the optical path, and the second optical component is configured to convert the spatial qubit, when retrieved from the atomic vapor memory, into an output qubit comprising the quantum information encoded in the arbitrary polarization state of a photon.

In some embodiments, the first optical component and/or the second optical component comprise: a polarization beam splitter (PBS); and one or more variable angle mirrors, each optically coupled to an output of the PBS.

In some embodiments, the filter module comprises: a first Fabry-Pérot cavity optically coupled to an input of the filter module; a Faraday rotator optically coupled to an output of the first Fabry-Pérot cavity; and a second Fabry-Pérot cavity optically coupled to an output of the Faraday rotator.

In some embodiments, the filter module further comprises: a first beam displacer disposed along an optical path of the filter module between the first Fabry-Pérot cavity and the Faraday rotator; and a second beam displacer disposed along the optical path between the Faraday rotator and the second Fabry-Pérot cavity.

In some embodiments, the first Fabry-Pérot cavity comprises: an external housing; an internal housing disposed within the external housing; a lens tube disposed within the internal housing; and an etalon disposed within the lens tube. In some embodiments, the external housing, the internal housing, and the lens tube are arranged to, in response to a change in temperature, uniformly deform in a direction perpendicular to an optical axis of the Fabry-Pérot cavity and to maintain a position of a center of the etalon on approximately the optical axis.

In some embodiments, the external housing comprises a material having a thermal expansion coefficient in a range from 5×10⁻⁶ K⁻¹ to 20×10⁻⁶ K⁻¹ at room temperature and a thermal conductivity in a range from 10 W/m·K to 20 W/m·K at room temperature. In some embodiments, the external housing is formed of 316L stainless steel. In some embodiments, the external housing is manufactured using additive manufacturing techniques.

In some embodiments, the internal housing and/or the lens tube comprises a material having a thermal expansion coefficient in a range from 10×10⁻⁶ K⁻¹ to 30×10⁻⁶ K⁻¹ at room temperature and a thermal conductivity in a range from 120 W/m·K to 150 W/m·K at room temperature. In some embodiments, the internal housing and/or the lens tube is formed of anodized aluminum 7075-T7 or anodized aluminum 7075-T8.

In some embodiments, the internal housing is press fit inside the external housing.

In some embodiments, an air gap is disposed between an exterior surface of the internal housing and an interior surface of the external housing. In some embodiments, aerogel insulation is disposed in the air gap. In some embodiments, a resistive heater foil wrap is disposed in the air gap.

In some embodiments, the first Fabry-Pérot cavity further comprises a ceramic resistive heater disposed within the external housing and adjacent an end of the internal housing.

In some embodiments, the lens tube is press fit inside the internal housing.

In some embodiments, the etalon is secured in the lens tube by: a first polished brass ring having a first thickness and disposed adjacent a first face of the etalon; and a second polished brass ring having a second thickness different than the first thickness and disposed adjacent a second face of the etalon, the second face of the etalon opposing the first face of the etalon.

In some embodiments, the first Fabry-Pérot cavity further comprises a thermistor embedded in the internal housing, the thermistor configured to monitor a temperature of the first Fabry-Pérot cavity.

Some aspects of the present application are directed to an atomic vapor memory, comprising: an atomic vapor cell containing an atomic vapor, the atomic vapor cell being elongated along a longitudinal axis and comprising two windows, each window of the two windows being disposed at opposing ends of the atomic vapor cell; and a first heater disposed adjacent a first window of the two windows, wherein the first heater comprises: a bifilar resistive wire wound in a toroidal arrangement and configured to generate approximately zero magnetic field at a center of the first heater, the center of the first heater being disposed in an optical path of the atomic vapor cell. In some embodiments, the bifilar resistive wire wound in a toroidal arrangement and configured to generate approximately zero magnetic field outside of the toroidal arrangement.

In some embodiments, the bifilar resistive wire is wound around a base ring comprising a high-temperature plastic or a ceramic. In some embodiments, the high-temperature plastic comprises polyetherimide (PEI) and/or polyether ether ketone (PEEK). In some embodiments, the base ring comprises grooves on a surface of the base ring, the grooves being configured to maintain the bifilar resistive wire in the toroidal arrangement. In some embodiments, the bifilar resistive wire comprises nichrome or graphene wire.

In some embodiments, the first heater is in thermal contact with the first window. In some embodiments, a thermally conductive O-ring maintains thermal contact between the first heater and the first window.

In some embodiments, the atomic vapor memory further comprises a second heater disposed adjacent a second face of the atomic vapor cell, the second heater comprising another bifilar resistive wire wound in a toroidal arrangement and configured to generate approximately zero magnetic field at a center of the second heater, the center of the second heater being disposed in an optical path of the atomic vapor cell.

In some embodiments, the atomic vapor comprises a rubidium vapor. In some embodiments, the atomic vapor comprises a vapor of ⁸⁷Rb.

In some embodiments, the atomic vapor memory further comprises a magnetic shielding apparatus arranged to at least partially encapsulate the atomic vapor cell and the first heater.

In some embodiments, the magnetic shielding apparatus comprises: a first magnetic shielding layer arranged to at least partially encapsulate the atomic vapor cell and the first heater; and a second magnetic shielding layer arranged to at least partially encapsulate the second magnetic shielding layer.

In some embodiments, the first magnetic shielding layer and the second magnetic shielding layer are each approximately cylindrical in shape, and the atomic vapor cell, the first magnetic shielding layer, and the second magnetic shielding layer are arranged concentrically about the longitudinal axis.

In some embodiments, the magnetic shielding apparatus further comprises: a first support disposed between the atomic vapor cell and the first magnetic shielding layer and configured to maintain a position of a center of the atomic vapor cell at approximately a center of the first magnetic shielding layer; and a second support disposed between the first magnetic shielding layer and the second magnetic shielding layer and configured to maintain a position of the center of the atomic vapor cell at approximately a center of the second magnetic shielding layer.

In some embodiments, the first support and/or the second support comprise a polymer. In some embodiments, the first support and/or the second support comprise polyetherimide (PEI) and/or polyether ether ketone (PEEK). In some embodiments, the first support and/or the second support are manufactured using additive manufacturing.

In some embodiments, the magnetic shield apparatus further comprises an outer shell, the outer shell comprising: a first shell and a second shell. The first shell comprises: a lower face; four side faces extending from the lower face; and an opening opposing the lower face, wherein: the first magnetic shielding layer is disposed within the first shell. The second shell comprises: an upper face disposed over the opening in the first shell; and two side faces extending from the upper face and substantially covering two of the four side faces of the first shell.

In some embodiments, the first shell comprises a first material and the second shell comprises a second material different than the first material. In some embodiments, the first material comprises Ad-Mu-00 magnetic shielding alloy. In some embodiments, the second material comprises aluminum 6061.

In some embodiments, two of the four side faces of the first shell that are not substantially covered by the two side faces of the second shell each comprise an optical window aligned with a window of the atomic vapor cell along the longitudinal axis.

In some embodiments, the second shell further comprises hold down features coupled to each of the two side faces of the second shell.

Some aspects of the present application are directed to a Fabry-Pérot cavity, comprising: an external housing; an internal housing disposed within the external housing; a lens tube disposed within the internal housing; and an etalon disposed within the lens tube, wherein: the external housing, the internal housing, and the lens tube are arranged to, in response to a change in temperature, uniformly deform in a direction perpendicular to an optical axis of the Fabry-Pérot cavity and to maintain a position of a center of the etalon on approximately the optical axis.

In some embodiments, the external housing comprises a material having a thermal expansion coefficient in a range from 5×10⁻⁶ K⁻¹ to 20×10⁻⁶ K⁻¹ at room temperature and a thermal conductivity in a range from 10 W/m·K to 20 W/m·K at room temperature. In some embodiments, the external housing is formed of 316L stainless steel. In some embodiments, the external housing is manufactured using additive manufacturing techniques.

In some embodiments, the internal housing and/or the lens tube comprises a material having a thermal expansion coefficient in a range from 10×10⁻⁶ K⁻¹ to 30×10⁻⁶ K⁻¹ at room temperature and a thermal conductivity in a range from 120 W/m·K to 150 W/m·K at room temperature. In some embodiments, the internal housing and/or the lens tube is formed of anodized aluminum 7075-T7 or anodized aluminum 7075-T8.

In some embodiments, the internal housing is press fit inside the external housing.

In some embodiments, an air gap is disposed between an exterior surface of the internal housing and an interior surface of the external housing.

In some embodiments, aerogel insulation is disposed in the air gap.

In some embodiments, a resistive heater foil is disposed in the air gap and in thermal contact with the internal housing.

In some embodiments, the Fabry-Pérot cavity further comprises a ceramic resistive ring heater that is disposed adjacent an end of the internal housing.

In some embodiments, the lens tube is press fit inside the internal housing.

In some embodiments, the etalon is secured in the lens tube by: a first polished brass ring having a first thickness and disposed adjacent a first face of the etalon; and a second polished brass ring having a second thickness different than the first thickness and disposed adjacent a second face of the etalon, the second face of the etalon opposing the first face of the etalon.

In some embodiments, the Fabry-Pérot cavity further comprises a thermistor embedded in the internal housing, the thermistor configured to monitor a temperature of the Fabry-Pérot cavity.

Some aspects of the present application are directed to an optical filter, comprising: a first Fabry-Pérot cavity optically coupled to an input of the optical filter; a Faraday rotator optically coupled to an output of the first Fabry-Pérot cavity; and a second Fabry-Pérot cavity optically coupled to an output of the Faraday rotator. In some embodiments, the optical filter further comprises a first beam displacer disposed along an optical path of the optical filter and between the first Fabry-Pérot cavity and the Faraday rotator; and a second beam displacer disposed along the optical path and between the Faraday rotator and the second Fabry-Pérot cavity.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a device housing 100 configured to house a quantum memory module and optionally a filter module, in accordance with some embodiments of the technology described herein.

FIG. 2 is a schematic diagram of a quantum memory 200 configured to store and retrieve quantum information encoded in a polarization state of a photon, in accordance with some embodiments of the technology described herein.

FIG. 3 is a schematic diagram of laser coupling schemes to energy levels of ⁸⁷Rb, in accordance with some embodiments of the technology described herein.

FIG. 4A is an illustration of an isometric view of a magnetic shielding apparatus 400, in accordance with some embodiments of the technology described herein.

FIGS. 4B and 4C are illustrations of cross-sectional views of the magnetic shielding apparatus 400, in accordance with some embodiments of the technology described herein.

FIG. 4D is an illustration of an isometric view of the magnetic shielding apparatus 400 with an outer housing removed, in accordance with some embodiments of the technology described herein.

FIG. 5 is an illustration of a heater 500 including a bifilar resistive wire wound in a toroidal arrangement, in accordance with some embodiments of the technology described herein.

FIG. 6A is a plot showing storage time of a quantum memory as a function of the probe field beam waist under different buffer gas pressures, in accordance with some embodiments of the technology described herein.

FIG. 6B is a plot of the normalized memory efficiency as a function of storage time for different probe beam waist values, in accordance with some embodiments of the technology described herein.

FIG. 6C is a plot of the normalized memory efficiency as a function of storage time for different buffer gas pressures, in accordance with some embodiments of the technology described herein.

FIG. 7 are plots of the storage efficiency, noise, signal-to-noise ratio (SNR), and optical depth as a function of atomic vapor temperature, in accordance with some embodiments of the technology described herein.

FIG. 8 is a plot of the storage efficiency and storage time as a function of buffer gas pressure, in accordance with some embodiments of the technology described herein.

FIG. 9A is a plot of the transmission of a probe field with different control field powers as a function of two-photon detuning, in accordance with some embodiments of the technology described herein.

FIG. 9B is a plot of temporal profiles of retrieved photons with different control field powers, in accordance with some embodiments of the technology described herein.

FIG. 9C is a plot of the full width at half maximum (FWHM) of electromagnetic induced transparency (EIT) and the FWHM of a retrieved photon as a function of control field power, in accordance with some embodiments of the technology described herein.

FIG. 10 is a schematic diagram of a filter 1000, in accordance with some embodiments of the technology described herein.

FIG. 11A is an illustration of an isometric view of a Fabry-Pérot cavity 1100, in accordance with some embodiments of the technology described herein.

FIGS. 11B and 11C are illustrations of cross-section views of the Fabry-Pérot cavity 1100, in accordance with some embodiments of the technology described herein.

FIG. 12 are plots of transmission through a Fabry-Pérot cavity and room temperature as a function of time, in accordance with some embodiments of the technology described herein.

FIG. 13A is a plot of measured operation error due to amplitude as a function of time, in accordance with some embodiments of the technology described herein.

FIG. 13B is a plot of measured operation error due to phase as a function of time, in accordance with some embodiments of the technology described herein.

FIG. 14 is a plot illustrating the storage and retrieval of photons from a combined quantum memory and filter device, in accordance with some embodiments of the technology described herein.

FIG. 15 is a plot of the storage efficiency and fidelity of a combined quantum memory and filter device as a function of the detection window size, in accordance with some embodiments of the technology described herein.

FIG. 16 is a plot of normalized storage efficiency as a function of storage time for two rails of the quantum memory, in accordance with some embodiments of the technology described herein.

### DETAILED DESCRIPTION

Quantum information science will enable unprecedented information integration, processing, and distribution capabilities. Similar to the evolution of the classical internet, where current applications were unimaginable in the earliest demonstrations of networking, the “quantum internet” has the potential to enable revolutionary applications such as unconditionally-secure secret key exchange, distributed quantum computation, enhanced quantum metrology, and tests of fundamental physics.

Given the expansive size of already-existing telecommunications fiber infrastructure, and the ease of processing information using photons, optical fiber networks are a prime candidate for hosting a global quantum network. However, despite decades of optimization for digital communication, the transmission loss (>0.2 dB/km) in optical fiber networks still presents considerable challenges to successful implementation of a quantum network, particularly because quantum states cannot be copied or amplified due to the no-cloning theorem. This constraint fundamentally limits the distances over which remote parties can be directly quantum networked at a reasonable rate.

A quantum repeater has been considered to overcome this challenge. In a quantum repeater, one divides a long communications channel into many elementary links and uses pair-wise entanglement swapping to distribute entanglement between the two remote parties. For most common quantum repeater schemes, a quantum memory is a core enabling device that allows single photons to be temporarily stored in a long-lived matter state and retrieved on-demand, enabling the storage of entanglement across elementary links. Because the entanglement process is probabilistic, the use of quantum memories provides an improvement in implementing entanglement swapping and significantly increases the entanglement distribution rate, serving as a foundation for global-scale quantum networks.

Quantum memories are devices capable of storing and retrieving photonic qubits on-demand. This functionality can be characterized by three parameters: fidelity, [symbol] , which describes the degradation of the input quantum state of the photons; storage efficiency, η, defined as the probability of storing and retrieving photons; and storage time, T, which assesses the time it takes for the storage efficiency to decay significantly. For a quantum memory in a quantum network, these parameters jointly determine the entanglement distribution rate and scaling over distances and can therefore be used to describe the “quantum performance” of the quantum memory.

The real potential of a quantum memories will be unleashed when they can be successfully integrated into existing telecommunication infrastructure, where a further set of metrics apply: fiber-hub compatibility, which prefers devices low in size, weight, and power consumption (SWaP); robustness against environmental noises (electromagnetic, thermal, mechanical); and scalability for mass deployment. These parameters can be used to describe the “hardware performance” of a quantum memory. A field-deployable quantum memory serving a large-scale quantum network should satisfy both sets of criteria for quantum and hardware performance.

Quantum memories with high levels of quantum performance have been realized in different physical systems, including ensembles of atoms or ions, rare-earth-doped crystals, defects in diamonds, and quantum dots. However, the supporting technology required to achieve high quantum performance from these systems are resource-intensive and include cryogenic cooling systems, ultrahigh vacuum systems, and sophisticated laser cooling and trapping schemes. The requirements of each of these systems, including requirements such as energy use, space requirements, cryogen use, and vibration isolation, are prohibitive to the deployment of these quantum memories in the field and in large-scale quantum networks.

The inventors have recognized and appreciated that integrating quantum technologies with existing telecommunications networks will lead to the ultimate realization of quantum networks operating over long distances. The inventors have further recognized and appreciated that warm atomic vapor systems are a promising platform for implementing a quantum memory with improved quantum and hardware performance because warm atomic vapor systems are a simple and robust physical platform that operate at, or above, room temperature e.g., in a range from 18° C. to 25° C.), without the need for cryogens or vacuum technologies.

The inventors have accordingly developed a self-contained quantum memory device based on a warm atomic vapor cell. The quantum memory device described herein boasts high fidelity retrieval (95%) at 5% storage efficiency and a long storage time (up to 1 ms). These performance metrics are consistent with the performance of well-controlled lab-based setups but are achieved in a rackmount form factor. The acceptance bandwidth of the quantum memory device described herein, which is approximately few MHz, is readily compatible with other atomic-based technologies, such as neutral atom quantum computers, trapped ions and nitrogen-vacancy centers. In addition, the operating wavelength of 795 nm permits high-fidelity, one-step frequency conversion to telecom bands (e.g., O- and/or C-bands) using nonlinear crystals or atomic media.

In some embodiments, the quantum memory device includes a housing configured to be rack-mounted (e.g., in a server rack, in a 19-inch rack) and a quantum memory module disposed in the housing. The quantum memory module may be configured to store an input qubit and/or to retrieve a stored qubit from memory (e.g., by storing the input qubit using the atomic vapor and/or retrieving the stored qubit from the atomic vapor).

In some embodiments, the housing may include a first base plate (e.g., a “blade”) supporting the quantum memory module and mechanically decoupling the quantum memory module from the housing. The first base plate may be configured to slidably move. For example, the first base plate may be configured to be slid out from the housing in a direction perpendicular to a front face of the housing so that a user may easily perform maintenance on the quantum memory module.

The inventors further recognized and appreciated that magnetically and thermally isolating the atomic vapor cell from other optical components of the quantum memory module may further improve performance of the quantum memory device. Accordingly, the inventors have developed a magnetic shielding apparatus arranged to at least partially encapsulate the atomic vapor cell (e.g., wherein the encapsulation allows optical access to the atomic vapor cell along the optical path, allows one or more cables to pass through the magnetic shielding, and/or allows a cold finger to make thermal contact with the atomic vapor cell).

In some embodiments, the magnetic shield apparatus may comprise an outer shell, a first magnetic shielding layer inside the outer shell, and a second magnetic shielding layer inside the first magnetic shielding layer. The outer shell, first magnetic shielding layer, and second magnetic shielding layer may be arranged approximately concentrically around the atomic vapor cell and the optical path through the atomic vapor cell. In some embodiments, the first and second magnetic shielding layers may be made of a material having a high magnetic permeability (e.g., Ad-Mu-80 or another suitable alloy).

In some embodiments, the first and second magnetic shielding layers may be held in place by first and second supports. The first support may be disposed between the atomic vapor cell and the first magnetic shielding layer, and the second support may be disposed between the first magnetic shielding layer and the second magnetic shielding layer. The first and second supports may comprise a polymer (e.g., a high-temperature polymer, including but not limited to polyetherimide (PEI) and/or polyether ether ketone (PEEK)). In some embodiments, the first and second supports may be manufactured using additive manufacturing techniques.

The inventors have further recognized and appreciated that a high measurement fidelity, [symbol] , may be achieved by filtering excessive noise photons from a retrieved output of the quantum memory module. Accordingly, the inventors further developed a filter module that may be included on a second base plate within the housing of the quantum memory device, in some embodiments. The second base plate may be vibrationally isolated from the housing and/or the quantum memory module and may be slidably moved in a same direction as the first base plate.

In some embodiments, the filter module may include two Fabry-Pérot cavities optically coupled in series along an optical path of the filter module. The Fabry-Pérot cavities include an external housing, an internal housing disposed within the external housing, a lens tube disposed within the internal housing, and an etalon disposed within the lens tube. In some embodiments, the arrangement of and/or the materials used to form the external housing, the internal, and the lens tube may be selected to cause, in response to a change in external temperature, uniform deformation in a direction perpendicular to an optical axis of the Fabry-Pérot cavity. Such uniform deformation along the direction perpendicular to the optical axis may maintain a position of the center of the etalon on or approximately on the optical axis (e.g., the etalon may remain centered on the optical axis even in response to temperature fluctuations).

Following below are more detailed descriptions of various concepts related to, and embodiments of, techniques for implementing field-deployable, room temperature quantum memory. It should be appreciated that various aspects described herein may be implemented in any of numerous ways. Examples of specific implementations are provided herein for illustrative purposes only. In addition, the various aspects described in the embodiments below may be used alone or in any combinations and are not limited to the combinations explicitly described herein.

### I. Quantum Memory Device

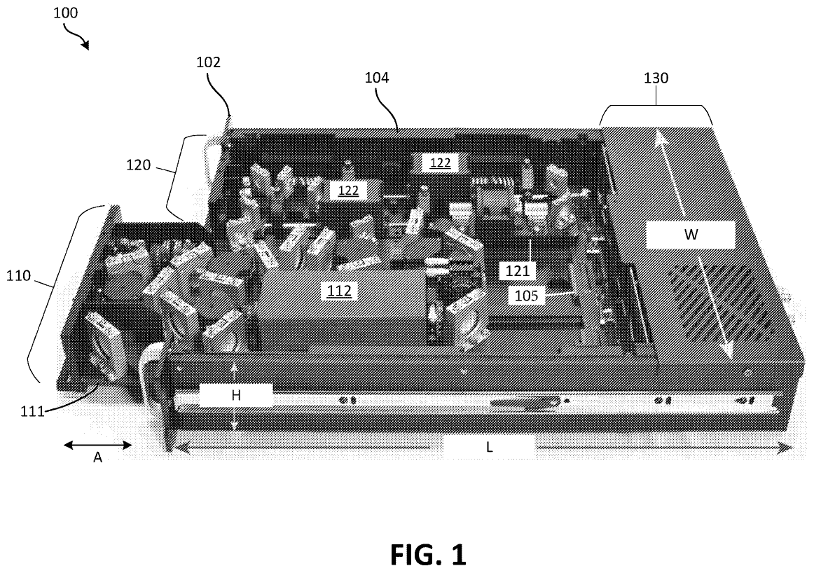

FIG. 1 shows a device housing 100 configured to house a quantum memory module 110 and optionally a filter module 120, in accordance with some embodiments of the technology described herein. The quantum memory module 110 may be configured to store quantum information (e.g., an input qubit) and/or to retrieve quantum information (e.g., a stored qubit) from a quantum memory (e.g., an atomic vapor cell). The quantum memory may be disposed within a magnetic shielding apparatus 112, in some embodiments and as shown in the example of FIG. 1.

In some embodiments, the filter module 120 may be configured to remove noise photons from an output of the quantum memory module 110. The filter module 120 may include Fabry-Pérot cavities 122 configured to filter an output signal from the device housing 100 (e.g., by removing extraneous photons remaining from the control beam).

In some embodiments, the device housing 100 may be configured to be rack-mounted. For example, in some embodiments, the device housing 100 may be configured to mounted in a standard server rack (e.g., a 19-inch or 24-inch server rack) and may have a standard length L of approximately 21 inches (e.g., 555 mm) and a width W of approximately 17 inches (e.g., 435 mm). The device housing 100 may additionally be configured to have a height H suitable for a 2U rackmount (e.g., having a height of approximately 3 to 3.5 inches or 80 mm). The use of a 2U form factor comfortably accommodates most free-space optical elements and mounts (up to 1 inch), while maintaining enough vertical space for mechanical assembly of the optical components.

In some embodiments, the quantum memory module 110 and/or the filter module 120 may be mounted on respective base plates 111 and 121 (e.g., “blades”). The base plates 111, 121 may be monolithic, tempered custom base plates configured to provide mechanical stability and improved optical performance. The base plates 111 and 121 may be slidably movable on internal mounting rails along the direction A, towards a forward housing face 102, such that a user can access each module (e.g., to diagnose or repair) without removing a lid (not shown) of the device housing 100. The quantum memory module 110 and the filter module 120 may be further shielded from each other and/or the environment with internal hoods configured to regulate the temperature and airflow across the free-space optical parts.

In some embodiments, the device housing 100 is configured to provide a well-controlled and stable local environment (e.g., providing stable temperature, pressure, and acoustic isolation) for the quantum optics of the quantum memory module 110 and/or the filter module 120. For example, mechanical vibrations can cause misalignment of optical components over time, particularly for components that have hysteresis (e.g., knobs). Accordingly, vibration damping within the device housing 100 and/or of the base plates 111 and 121 may improve performance of the quantum memory device.

In some embodiments, the device housing 100 may include one or more systems to provide vibration isolation to the quantum memory module 110 and/or the filter module 120. As a first example, the device housing 100 may include a barrier material 104 which lines one or more interior surfaces of the device housing 100. The barrier material 104 may dampen high-frequency vibrations (e.g., acoustic vibrations). Additionally or alternatively, the barrier material 104 may thermally insulate the interior of the device housing 100 to reduce thermal shock (e.g., if the exterior environment around the device housing 100 rapidly changes temperature). Such thermal insulation may be configured to prevent thermal drift of the optical components within the device housing 100, thereby improving the performance of the quantum memory module 110 and/or the filter module 120.

In some embodiments, the base plates 111 and/or 121 may be partially or fully mechanically decoupled from the device housing 100. In particular, the base plates 111 and/or 121 may be vibrationally isolated using economical, passive vibration isolation systems to provide long-term stability of the optical components and their mounting elements within the device housing 100. Vibrationally isolating the base plates 111 and/or 121 may isolate the quantum memory module 110 and/or the filter module 120 from vibrations caused by airflow and/or fans (e.g., within the electronics module 130 and/or from nearby equipment in rack cabinets).

In some embodiments, the base plates 111 and/or 121 may be equipped with a passively dampened internal rail system bolted to the solid skeleton of the enclosure. For example, in some embodiments, the base plates 111 and/or 121 may be vibrationally isolated using shock absorbers. For example, shock absorbers made of rubber or rubber-like materials (e.g., SORBOTHANE, a product of Sorbothane, Inc.) may be used to vibrationally isolate the base plates 111 and/or 121. Alternatively or additionally, in some embodiments, commercially available elements (e.g., VIBe Super Compact Mechanical Vibration Isolators manufactured by Newport Corp.) specifically designed to filter vibrations (e.g., using nonlinear spring mechanisms) in frequency ranges likely to effect optical assemblies may be used to vibrationally isolate the base plates 111 and/or 121.

In some embodiments the base plates 111 and/or 121 may be suspended within the device housing 100. For example, wire rope loop isolators (not shown) may be used to suspend base plates 111 and/or 121 within the device housing 100. Wire rope loop isolators may be used to suspend base plates 111 and/or 121 either vertically or horizontally within the device housing 100.

In some embodiments, the device housing 100 may be partitioned into two spaces: one containing quantum optics devices and one containing support electronics in an electronics module 130. The supporting electrical components reside in the electronics module 130, located at the rear of the device housing 100. A motherboard with interchangeable slots allows a custom circuit board to control each quantum device (e.g., providing precision temperature servos) via card edge connector 105 (e.g., manufactured by Sullins Connector Solutions) under each base plate 111, 121. This arrangement enables easy maintenance and the flexibility to implement upgrades and to host different quantum devices. Additionally, in some embodiments, the motherboard may also provide Ethernet and/or USB interfaces providing remote access capabilities which may allow users to monitor, control, and debug devices remotely through an API. In some embodiments, the total power consumption of the electronics module 130 is 15 W with the quantum memory module 110 and the filter module 120 in operation.

### II. Quantum Memory Module

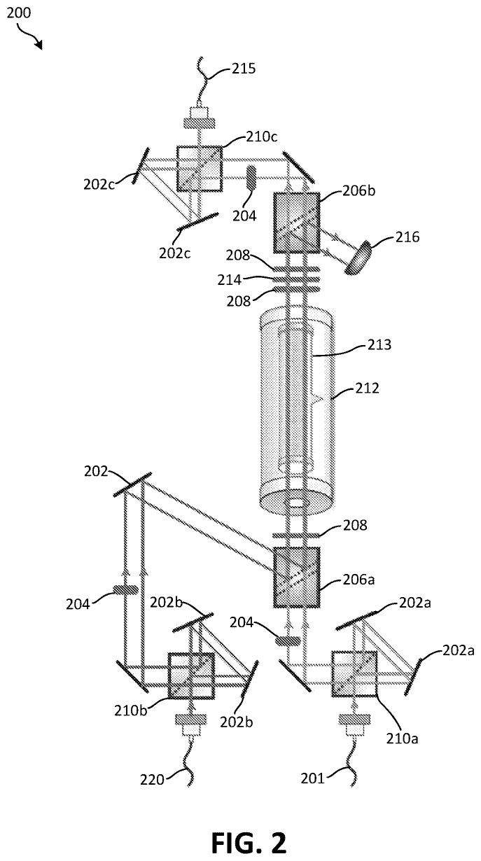

FIG. 2 is a schematic diagram of a quantum memory 200 configured to store and retrieve quantum information encoded in a polarization state of a photon, in accordance with some embodiments of the technology described herein. In some embodiments, the quantum memory 200 may be disposed in the device housing 100 of the example of FIG. 1 as the quantum memory module 110.

During operation of the quantum memory 200, a photon carrying quantum information in its polarization degree of freedom (e.g., in an arbitrary polarization state) is mapped onto a collective spin state of a warm vapor of ⁸⁷Rb atoms to store the quantum information. The quantum information may then later be retrieved using a strong control field.

In the example of FIG. 2, input 201 is an input port in which qubits (e.g., encoded in the polarization state of a photon or photons) enter quantum memory 200. In some embodiments, the input qubits travel from input 101 to a first polarization beam splitter (PBS) 210a, which is configured to separate the two orthogonal polarization modes (IH) and IV)) into two spatial rails, enabling the storage and retrieval of photons having any arbitrary polarization state in the light-matter interface 212.

In some embodiments, the first PBS 210a, in combination with variable angle mirrors 202a, is arranged as a mixed-angle Sagnac interferometer that converts a received qubit encoded in the polarization state of a photon into a spatial qubit propagating along parallel optical rails. The first PBS 210a may be configured to encode the spatial qubit into the amplitude and the phase of the superposition of a single photon propagating along the parallel optical rails. For example, if the received qubit were encoded in an arbitrary polarization state of a|H [symbol] +be^{iθ}|V [symbol] , the spatial qubit output by the module 110 is encoded in the spatial state of a|L [symbol] +be^{iθ}|R [symbol] , where |L [symbol] and |R [symbol] are the left and right rails, respectively, and iθ is the phase.

In some embodiments, the quantum memory 200 may include a control field input 220. Control field input 220 is an input port for a control field laser beam. The control field laser beam is configured to control the process of storing and retrieving the qubits from quantum memory 200. Control qubits are directed from the control field input 220 to second PBS 210b, which is also arranged as a mixed-angle Sagnac interferometer in combination with variable angle mirrors 202b. PBS 210b and variable angle mirrors 202b are configured to split the received control field qubits into two identical, but spatially separated, control field beams.

In some embodiments, after the pair of spatial qubits exit the PBS 210a, they enter a first device 206a. The first device 206a is configured to redirect the spatial qubit into the light-matter interface 212. In some embodiments, the first device 206a may be a polarization beam splitter (e.g., a Glan-Taylor polarizer or a Glan-Laser prism (GLP)). Additionally, the first device 206a may be configured to combine the pair of spatial qubits with the two control field beams received from second PBS 210b with the pair of spatial qubits received from the first PBS 210a before the spatial qubits enter the light-matter interface 212.

In some embodiments, the light-matter interface 212 may include the magnetic shielding apparatus 112 of the example of FIG. 1 and one or more atomic vapor cells 213 configured to store the quantum information carried by the pair of spatial qubits. For example, the one or more atomic vapor cells 213 may include a vapor of certain isotopes that can absorb and store the quantum information (e.g., atoms of Rb, atoms of ⁸⁷Rb, atoms of Cs, or atoms of any other suitable alkali metal). In some embodiments, the atomic vapor cells 213 contain an ⁸⁷Rb vapor that is greater than 99% enriched. The atomic vapor cells 213 may contain this vapor within a cylindrical glass (e.g., quartz) cell that is approximately 80 mm long and 25.4 mm in diameter, in some embodiments.

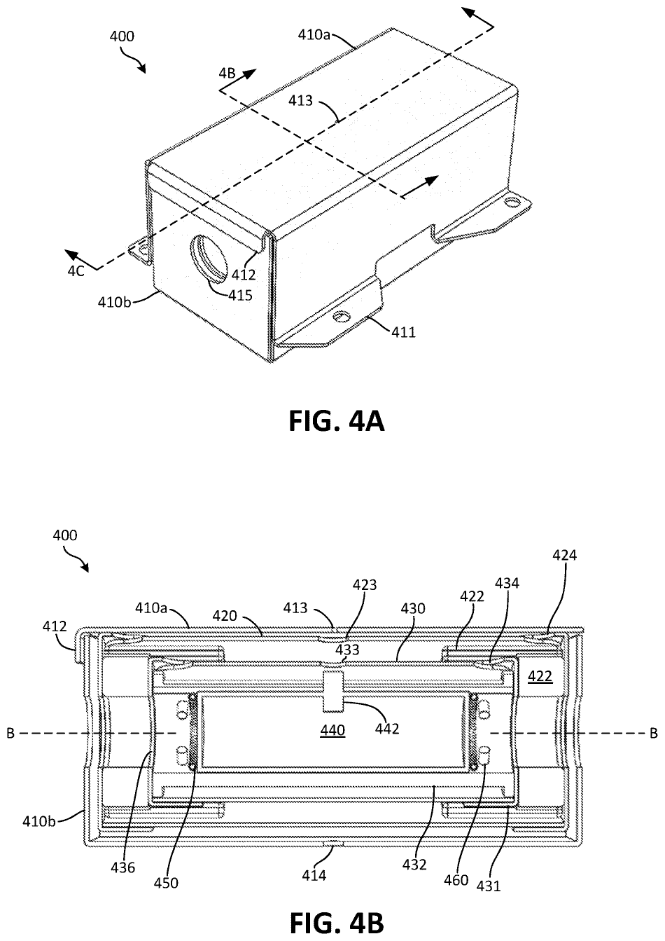

In some embodiments, the atomic vapor cells 213 may be enclosed in a temperature-controlled and magnetically shielded container (e.g., formed of Mu-metal), as described in more detail in connection with FIGS. 4A-4D herein. It should be appreciated that though the illustration of FIG. 2 shows only a single atomic vapor cell 213, the quantum memory 200 may include more than one (e.g., two, three, four, etc.) atomic vapor cells 213, as aspects of this technology are not limited in this respect.

In some embodiments, after the spatial qubit is stored in the atomic vapor cells 213, the qubit may be retrieved from the atomic vapor cell 213 and directed to the second device 206b. The second device 206b may be a polarization beam splitter (e.g., a Glan-Taylor polarizer or a Glan-Laser prism (GLP)) and may be configured to separate the spatial qubit from the control field beams. The control field beams may be redirected and removed using beam trap 216. The second device 206b may filter the control field beams with a suppression greater than or equal to 50 dB, in some embodiments.

After exiting the second device 206b, the spatial qubits may be directed to the third PBS 210c that, in combination with variable angle mirrors 202c, may be arranged as a mixed-angle Sagnac interferometer. The third PBS 210c and variable angle mirrors 202c may be configured to map the spatial qubit back into a polarization qubit (e.g., into a single photon with the qubit encoded in an arbitrary polarization state of the photon). The polarization qubit may then be directed to the output port 115, from which quantum memory 200 may output retrieved polarization qubits.

In some embodiments, the quantum memory 200 includes a number of optical components configured to adjust the polarization of the spatial qubits and/or the control field beams. For example, the quantum memory 200 may include one or more polarization plane rotators (PPRs) 204 configured to rotate a polarization of a single rail (e.g., by 90°, to make the polarization of each rail substantially identical). Additionally or alternatively, the quantum memory may include one or more quarter wave plates (QWPs) 208 and/or a half wave plate (HWP) 214 configured to adjust the polarization of both rails. For example, the QWP 208 placed between the first device 206a and the light-matter interface 212 may be configured to convert the polarization of both rails to σ0^{+,-} before these fields interact with the atomic vapor within the atomic vapor cells 213.

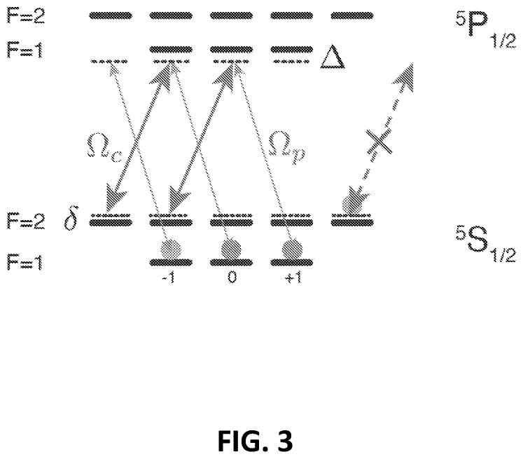

As configured in the example of FIG. 2, the quantum memory 200 is configured to store photonic polarization qubits that are near-resonant with the F=1 to F′=1 transition of the rubidium D1 line, as explained in connection with FIG. 3 herein. FIG. 3 is a schematic diagram of laser coupling schemes to energy levels of ⁸⁷Rb based on electromagnetic induced transparency (EIT), in accordance with some embodiments of the technology described herein.

In some embodiments, a strong control field Ω_{c}, may be used to address the F=2 to F′=1 transition of the rubidium D1 line. This strong control field Ω_{c} opens an EIT window under which a probe photon (e.g., a photon of the spatial qubit to be stored in the atomic vapor cells 213), Ωₚ, on two-photon resonance can propagate. By turning Ω_{c} off when the probe photon is within the atomic medium, it may be mapped onto a hyperfine F=1,2 spin wave (SW) of the Rb atoms. Turning Ω_{c} back on at a later time maps the SW back into a propagating photon which may be retrieved from the atomic vapor cells 213 four output.

In some embodiments, a memory operation starts with 50 μs of optical pumping with the Ω_{c} field. The Ω_{c} field may be referenced to the ⁸⁷Rb transition energy using saturated absorption spectroscopy. The 50 μs of optical pumping with the Ω_{c} field results in a steady-state distribution with atoms of the atomic vapor nearly evenly divided among these four states: |2, +2 [symbol] , |1, +1 [symbol] , |1, 0 [symbol] , |1, −1 [symbol] . The last two states participate in the memory operation.

For storage, a pulse of Ωₚ field enters the atomic medium under the EIT created by the Ω_{c} field. The pulse is compressed as it propagates in the atomic vapor cells 213 due to the reduced group velocity inside the atomic vapor. After the pulse of Ωₚ field enters the atomic medium, the Ω_{c} field is rapidly switched off, mapping the Ωₚ pulse onto a SW of the atomic vapor. To retrieve the qubit, the Ω_{c} field is turned back on, mapping the SW back to the Ωₚ field in a time-reversal manner. The Ωₚ field may be beatnote locked to be detuned from the Ω_{c} field by approximately the ground-state hyperfine splitting of the atomic vapor. Additionally, the single photon detuning Δ may be fixed to −2π×120 MHz while the two-photon detuning, δ, may be varied.

### III. Magnetic Shielding and Heating of the Atomic Vapor Cell

Magnetic fields cause dephasing of the quantum state of atoms by shifting their Zeeman levels. The Zeeman splitting of Rb atoms connects the characteristic dephasing time with the magnetic field. A detailed calculation is provided herein.

Multiple processes can cause dephasing, or effective dephasing, of the spin wave (SW) stored in the atomic vapor. In general, the storage efficiency is proportional to the overlap integral of the initial spin wave, S(r), and the overlap integral of the spin wave at the retrieval time, S′(r):

η∝|∫drS*(r)S′(r)|²

Due to the differing magnetic field sensitivities of the states involved in the SW, magnetic field gradients can cause different parts of the SW to precess at different rates, therefore cause dephasing. The effect of magnetic field gradients on the SW coherence is calculated below.

In the atomic vapor systems described herein, the longitudinal extent of the SW is significantly larger than that in the radial direction. Additionally, the inclusion of magnetic shielding means the magnetic field gradient in the radial direction is significantly smaller than in the longitudinal direction. Therefore, here only a gradient along the axis of the SW is considered.

After some storage time the spin wave can be written as:

$${S}^{′} ( z ) = S ( z ) {e}^{- i Δ ( z ) t} ,$$

where Δ(z) is the position dependent energy shift due to the magnetic field. If it is assumed that the magnetic field has a linear gradient: B(z)=B₀+B′z, then the SW can be written as:

$${S}^{′} ( z ) = S ( z ) {e}^{- i ( {B}_{0} + {B}^{′} z ) {ε}_{ℬ} t} ,$$

where [symbol] is the shift per unit magnetic field.

If it is further assumed that S(z) is constant, then the storage efficiency is given by:

$$η ∝ {\vert {\int }_{0}^{L} \frac{d z}{L} {e}^{- i ( {B}_{0} + {B}^{′} z ) {ε}_{ℬ} t} \vert}^{2} \\ ∝ {sinc}^{2} ( \frac{{B}^{′} {ε}_{ℬ} L t}{2} )$$

where L is the spatial extent of the spin wave.

In warm atom systems, external magnetic fields can cause decoherence within the atomic vapor (e.g., by introducing Zeeman splitting, described above), reducing coherence times of the quantum memory. External magnetic fields may be introduced by the ambient environment (e.g., the Earth's magnetic field) or by nearby electronics. The inventors have recognized and appreciated that magnetic shielding may reduce and/or mitigate the effects of external magnetic fields on the atomic vapor; in particular, magnetic shielding may mitigate any residual fields having a direction that is not parallel to the optical axis, as such residual fields are most likely to cause decoherence within the atomic vapor.

Additionally, for a warm atom system to function, the atomic vapor must be heated above room temperature (to approximately a range from 40° C. to 70° C.). However, the inventors have recognized and appreciated that introducing a source of heat within a small housing (e.g., device housing 100) may impact other optical components of the quantum memory module within the housing. Additionally, the source of heat itself may introduce additional magnetic fields that are detrimental to the coherence time of the atomic vapor. Accordingly, the inventors have developed (i) a magnetic shielding apparatus configured to both shield the atomic vapor cell from ambient magnetic fields and to thermally isolate the heating of the atomic vapor cell and (ii) a resistive heater that introduces minimal magnetic field in the optical path of the atomic vapor cell.

FIGS. 4A-4C are illustrations of different views of a magnetic shielding apparatus 400, and FIG. 4D is an illustration of an isometric view of the magnetic shielding apparatus 400 with an outer housing removed, in accordance with some embodiments of the technology described herein. The outer housing, shown in the example of FIG. 4A, includes a first shell 410a and a second shell 410b at least partially encapsulating the atomic vapor cell 440 and heaters 450.

In some embodiments, the first shell 410a is approximately U-shaped and includes two sides extending downwards to partially cover two sides of the second shell 410b and two clamping portions 412 configured to secure the first shell 410a to the second shell 410b. The first shell 410a further includes hold down portions 411 (e.g., including mounting holes) configured to couple the magnetic shielding apparatus 400 to a mounting surface (e.g., to a surface of the base plate 111) while maintaining thermal isolation of the atomic vapor cell 440 inside the magnetic shielding apparatus 400. In some embodiments, the first shell 410a optionally includes a vent 413 (e.g., to reduce condensation build up within the magnetic shielding apparatus 400).

In some embodiments, the second shell 410b includes an opening 414 on a lower surface of the second shell 410b. The opening 414 may be configured to allow a cold finger (e.g., for cooling the atomic vapor cell 440) to enter the magnetic shielding apparatus 400. The opening 414 may be optionally included or not included in the magnetic shielding apparatus 400.

In some embodiments, the second shell 410b includes optical windows 415 configured to allow light to enter and exit the magnetic shielding apparatus 400 through the side walls of the second shell 410b that are not covered by the first shell 410a. The optical windows 415 may be centered around the longitudinal axis B and disposed within the optical path of the atomic vapor cell 440.

In some embodiments, the first and second shells 410a and 410b may serve as an enclosing shell configured to entrap heat within the magnetic shielding apparatus 400. This may also serve to protect nearby external optics components from heat exposure. In some embodiments, inner walls of the first and second shells 410a and 410b may be lined with a heat barrier (e.g., a protective foam) configured to thermally isolate the interior of the magnetic shielding apparatus 400 from the external environment. In some embodiments, when the atomic vapor cell 440 is maintained at 60° C., the first and second shells 410a and 410b may be approximately less than or equal to 30° C.

In some embodiments, the first shell 410a may be made of a machinable material. For example, the first shell 410a may be made out of aluminum 6061 with a powder coating. In some embodiments, the second shell 410b may be made of a material having a low magnetic permeability. For example, the second shell 410b may be made of a Mu-metal (e.g., Ad-Mu-00). In such embodiments, the second shell 410b may provide saturation induction protection to the interior magnetic shielding layers, reducing degaussing requirements of the inner layers in the event of exposure to a temporary magnetic field. Alternatively, the second shell 410b may be made out of a non-magnetic material (e.g., aluminum 7075).

In some embodiments, the magnetic shielding apparatus 400 may further include two magnetic shielding layers 420 and 430, each of the magnetic shielding layers at least partially encapsulating the atomic vapor cell 440. In some embodiments, the magnetic shielding layer 430 may at least partially encapsulate the atomic vapor cell 440 and the magnetic shielding layer 420 may at least partially encapsulate the magnetic shielding layer 430.

In some embodiments, the atomic vapor cell 440 and the magnetic shielding layers 420, 430 may be approximately cylindrical in shape and may have lengths extending along the longitudinal axis B. The atomic vapor cell 440 and the magnetic shielding layers 420, 430 may be arranged approximately concentrically about the longitudinal axis B.

In some embodiments, the magnetic shielding layers 420 and 430 may comprise a material having a high magnetic permeability. For example, the magnetic shielding layers 420 and 430 may comprise Ad-Mu-80 or any other suitable alloy (e.g., a Mu-metal). In some embodiments, the magnetic shielding layer 420 may be approximately 0.08 inches thick and the magnetic shielding layer 430 may be approximately 0.06-0.08 inches thick.

In some embodiments, the diameters and lengths of the magnetic shielding layers 420 and 430 are calculated via a simulation program to maximize the shielding factor and to minimize the inside transversal gradient. The maximum diameter of the magnetic shielding layer 420 may be dictated by the available height within the device housing (e.g., within a 2U rackmount). The surrounding optics may also limit the available length.

In some embodiments, the magnetic shielding apparatus 400 also includes supports 422 and 432 configured to maintain the relative concentric, symmetrical positions of each of the magnetic shielding layers 420 and 430 and the atomic vapor cell 440. The supports 422 and 432 may be formed of materials resistant to high temperatures (e.g., greater than 60° C.) and that are non-ferromagnetic. For example, the supports 422 and 432 may be formed of high-temperature polymers (e.g., polyetherimide (PEI) and/or polyether ether ketone (PEEK)). In some embodiments, the supports 422 and/or 432 may be manufactured using additive manufacturing (e.g., three-dimensional printing) techniques, such that the supports 422 and/or 432 may be formed into complex structures that minimize the material used and enable the performance of multiple functions (e.g., clamping lids of the magnetic shielding layers 420 and/or 430, securing the magnetic shielding layers 420 and/or 430, and/or securing the atomic vapor cell 440).

In some embodiments, the magnetic shielding layers 420 and 430 may include optical windows 426 and 436, respectively. The optical windows 426 and 436 may be aligned with one another and the optical windows 415 of the outer shell along the longitudinal axis B. The optical windows 426 and 436 may also be configured to allow light to enter and exit the atomic vapor cell 440 along its optical path. In some embodiments, the optical windows 426 and/or 436 may be approximately 18 mm in diameter.

In some embodiments, the magnetic shielding layers 420 and 430 may include optional openings 423 and 433, respectively. The openings 423 and 433 may be configured to allow a cold finger to contact the vapor cell sealing stem 442 of the atomic vapor cell 440. The optional inclusion of the cold finger and openings 423 and 433 ensures that the vapor cell sealing stem 442 is the coldest location of the body, preventing condensation from building up on optical windows of the atomic vapor cell 440 (e.g., the faces of the atomic vapor cell 440 that are perpendicular to the longitudinal axis B).

In some embodiments, the magnetic shielding layers 420 and 430 may include openings 424 and 434, respectively. The openings 424 and 434 may be configured to allow wires (e.g., to couple to the heaters and sensors inside the magnetic shielding layer 430) to pass from the external environment to the interior of the magnetic shielding layer 430. In some embodiments, the openings 424 and 434 are filleted openings that to allow the wires to pass through the end caps 421 and 431, respectively. The end caps 421 and 431 may be removable even when cables are present to enable easy maintenance of the atomic vapor cell 440.

In some embodiments, the magnetic shielding apparatus 400 may include heaters 450 that are disposed adjacent the faces of the atomic vapor cell 440. These faces may comprise windows (e.g., glass and/or quartz windows) that are configured to allow light to enter and exit the atomic vapor cell 440. In some embodiments, the heaters 450 may be placed in thermal contact with the windows of the atomic vapor cell 440. For example, a thermally conductive O-ring (e.g., a silicon O-ring; not shown) may maintain thermal contact between each of the heaters 450 and the windows of the atomic vapor cell 440. By positioning the heaters 450 adjacent the windows and maintaining the windows as the warmest portion of the magnetic shielding apparatus 400, condensation entering through the optical windows 415, 426, and 436 may be prevented from accumulating on the windows of the atomic vapor cell 440.

Conventional resistive heaters usually generate heat by passing current through a resistive wire; however, such current flow will generate a magnetic field. The inventors have recognized and appreciated that heaters 450, which are disposed inside of the innermost magnetic shielding layer 430, ideally should not generate any magnetic field in any regions along the optical path of the atomic vapor cell 440 in order to prevent decoherence effects.

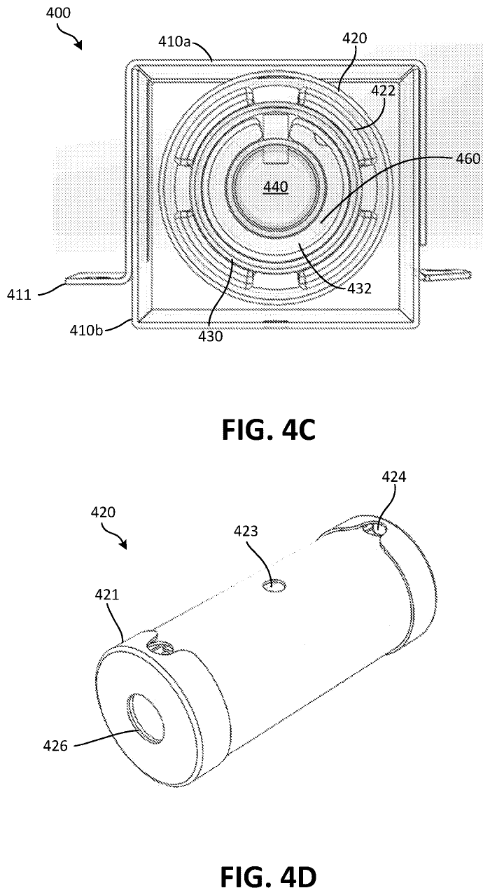

Accordingly, the inventors have developed a resistive ring heater 500 arranged to generate approximately zero magnetic field at its center, as illustrated in FIG. 5 and in accordance with some embodiments of the technology described herein. In some embodiments, the resistive ring heater 500 may be used as heaters 450 in the magnetic shielding apparatus 400 of FIGS. 4A-4D.

In some embodiments, the heater 500 may include a bifilar resistive wire 510 wound in a toroidal arrangement about a center C. The bifilar resistive wire 510 may be formed of an enamel-insulated, high-resistance wire (e.g., nichrome or graphene), as high-resistance wire generates heat in response to the application of a lower current, which generates a smaller magnetic field.

The bifilar resistive wire 510 may include be wound around a base ring 520, in some embodiments. The base ring 520 may be formed of a material able to endure temperatures greater than 100° C. without deforming. For example, the base ring 520 may be formed of a high-temperature polymer (e.g., PEI and/or PEEK) or a ceramic. In some embodiments, a thermistor may be embedded in the base ring 520 to enable the monitoring of the temperature at one or both faces of the atomic vapor cell 440. Additionally, in some embodiments, the base ring 520 may include indents on its exterior surface to secure the resistive wire 510 in its spooled arrangement.

In some embodiments, the bifilar resistive wire 510 may be wound in an arrangement configured to generate approximately zero magnetic field at the center C. The bifilar resistive wire 510, for example, may be wound in an arrangement configured to confine a majority of generated magnetic field within a region occupied by the base ring 520.

Returning to FIGS. 4A-4D, in some embodiments, the positions of the atomic vapor cell 440 and the heaters 450 may be maintained within the magnetic shielding apparatus 400 by retaining dowels 460. The retaining dowels 460 may be formed of a high-temperature polymer (e.g., PEEK) and may pass through openings in the supports 422 and/or 432 at designated locations. The retaining dowels 460 may be configured to clamp the heaters 450 against the faces of the atomic vapor cell 440 without applying pressure to the heaters 450 and/or the faces of the atomic vapor cell 440 (e.g., to avoid birefringence differences on the glass and/or quartz faces of the atomic vapor cell 440). Rather, the retaining dowels 460 may provide a stop lock that prevents the heaters 450 from sliding away from the faces of the atomic vapor cell 440 and/or may prevent the atomic vapor cell 440 from shifting away from the center of the magnetic shielding apparatus 400.

### IV. Parameters Effecting Quantum Memory Performance

### A. Storage Time

In a quantum repeater network, the storage time of a quantum memory may heavily limit the total network length, and is therefore an important metric for gauging memory performance. In the quantum memory described herein (e.g., quantum memory 200), photons are stored in the form of a spin wave (SW) on ⁸⁷Rb atoms. The primary decoherence mechanisms of this SW are atomic free motion and inhomogeneous magnetic fields. Described herein is a systematic study of these decoherence mechanisms and corresponding strategies to achieve a 1/e storage time of ˜0.8 ms.

Because the quantum state of an input photon is encoded in an atomic vapor with atoms of a finite size, free atomic motion causes decoherence. By co-propagating the Ω_{c} and Ωₚ fields, a maximum SW wavelength of λ_{SW}=4.3 cm may be achieved in the longitudinal direction. Transversely, the SW is defined by the probe field profile. Because a typical beam size is approximately a few millimeters and is <<λ_{SW}, the diffusion of atoms in the radial direction is the primary dephasing mechanism, while the longitudinal dephasing is secondary.

By adding buffer gas (Ne) to the atomic vapor cell (e.g., atomic vapor cell 440), this diffusion is significantly slowed. The diffusion constant D may be determined by the buffer gas pressure according to

$$D = {D}_{0} \frac{{P}_{0}}{P} ,$$

where P₀ and D₀ are defined at 760 Torr. The decay of the storage efficiency due to this diffusion process is modeled below and predicts the dependence of T on the buffer gas pressure, P_{Ne}, and beam size, w.

In warm atom systems a major contributor to dephasing is the motion of atoms after storage. In the atomic vapor cells described herein, the radial size of the SW, which may be approximately a few millimeters in length, is significantly smaller than the wavelength of the SW (λ_{SW}=4.3 cm). Therefore, radial, as opposed to longitudinal, motion of the atoms is the dominant process of dephasing to consider.

When the SW is stored, it may be assumed that the SW has a two-dimensional Gaussian profile identical to that of the probe beam profile:

$$\vert S ( x , y ) \vert = \frac{2}{π {w}^{2}} {e}^{- 2 \frac{{x}^{2} + {y}^{2}}{{w}^{2}}} ,$$

where w is the 1/e² radius of the probe field.

After a time, t, the transverse spatial profile of the SW is given by:

$${\vert {S}^{′} ( x , y ) \vert}^{2} = \int \int {dx}^{′} {dx}^{″} {dy}^{′} {dy}^{″ {\vert {S}^{′} ( x , y ) \vert}^{2}} C ( {x}^{″} ) C ( {y}^{″} ) δ ( x - ( {x}^{′} + {x}^{″} ) ) δ ( y - ( {y}^{′} + {y}^{″} ) ) ,$$

$$where$$

$$C ( x ) = \frac{1}{2 \sqrt{π D t}} {e}^{- \frac{{x}^{2}}{4 Dt}}$$

is the spatial profile of diffusion from a point source, with a diffusion constant D.

Performing the integration yields:

$$\begin{matrix}{\vert {S}^{′} ( x , y ) \vert}^{2} = \frac{2}{π ( 8 Dt + {w}^{2} )} {e}^{- 2 \frac{{x}^{2} + {y}^{2}}{8 Dt + {w}^{2}}} \\ = \frac{2}{π {w}^{′ 2}} {e}^{- 2 \frac{{x}^{2} + {y}^{2}}{{{w}^{′}}^{2}}}\end{matrix}$$

where w′²=w²+8Dt.

If it is assumed that the expansions impart no radial phase upon the atoms, then the storage efficiency is given by:

$$η ∝ \frac{4 {w}^{2} {w}^{′ 2}}{{( {w}^{2} + {w}^{′ 2} )}^{2}}$$

$$∝ 1 - \frac{1}{{( 1 + \frac{{w}^{2}}{4 Dt} )}^{2}} .$$

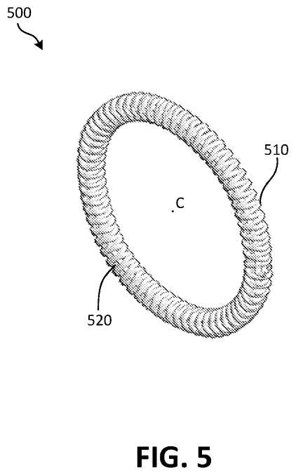

FIG. 6A is a plot showing the measured storage time, T, of the quantum memory 200 as a function of the probe field beam waist under different buffer gas (Ne) pressures, in accordance with some embodiments of the technology described herein. The storage time, T, is defined as the 1/e decay time of the storage efficiency, η. The experiment is performed with weak laser pulses as the probe field (<1 μW).

The solid lines 602a, 604a, 606a, and 608a represent a collective fit over all data points with two free parameters: the Rb atom diffusive constant, D₀, and the longitudinal magnetic field gradient. The dashed lines 602b, 604b, 606b, and 608b represent the inferred storage time without a magnetic field gradient. The lines 602a and 602b represent fits to data measured using an atomic vapor cell having a buffer pressure of 2 Torr, the lines 604a and 604b represent fits to data measured using an atomic vapor cell having a buffer pressure of 10 Torr, the lines 606a and 606b represent fits to data measured using an atomic vapor cell having a buffer pressure of 20 Torr, and the lines 608a and 608b represent fits to data measured using an atomic vapor cell having a buffer pressure of 30 Torr. The beam waist implemented in the quantum memory 200 is 1.6 mm as represented by the vertical dotted line 610.

As shown by FIG. 6A, the storage time, T, generally increases with increased buffer gas pressure, P_{Ne}, and beam waist values, w. However, in the high P_{Ne} and large w limit, there is a divergence between the simple theory (dashed lines 602b, 604b, 606b, and 608b) and the experimental results (data points), which suggests that T may be bottlenecked by some additional mechanism other than the atomic diffusion.

This additional dephasing mechanism may be attributed to a slight magnetic field gradient in the longitudinal direction. The optical access through the optical windows of the magnetic shielding apparatus (e.g., optical windows 415, 426, and 436) may compromise the magnetic shielding capability along this direction, and the long SW makes the memory more sensitive to small magnetic field gradients. This magnetic dephasing may be taken into account to generate the predictions of lines 602a, 604a, 606a, and 608a, which match well with experimental results. These results show an achieved T=0.8 ms, which could support a metropolitan-scale quantum network.

FIG. 6B is a semi-log plot of the normalized memory efficiency, η_{N}, as a function of storage time for different probe beam waist values, in accordance with some embodiments of the technology described herein. This data was collected using an atomic vapor cell having a buffer gas (Ne) pressure of 2 Torr. Line 612 corresponds to an exponential fit to data acquired with a beam waist of 0.65 mm, line 614 corresponds to an exponential fit to data acquired with a beam waist of 1.1 mm, line 616 corresponds to an exponential fit to data acquired with a beam waist of 2.4 mm, and line 618 corresponds to an exponential fit to data acquired with a beam waist of 3.9 mm. As shown by FIG. 6B, the storage time, T, generally increases with increased beam waist values, w, and in fact scales quadratically with w.

FIG. 6C is a plot of the normalized memory efficiency, η_{N}, as a function of storage time for different buffer gas (Ne) pressures, in accordance with some embodiments of the technology described herein. This data was collected using a beam waist value of 0.65 mm. Line 620 corresponds to an exponential fit to data acquired with a buffer gas pressure of 2 Torr, line 622 corresponds to an exponential fit to data acquired with a buffer gas pressure of 10 Torr, line 624 corresponds to an exponential fit to data acquired with a buffer gas pressure of 20 Torr, and line 626 corresponds to an exponential fit to data acquired with a buffer gas pressure of 30 Torr. As shown by FIG. 6B, the storage time, T, generally increases with increased buffer gas pressure, P_{Ne}, and in fact scales linearly with P_{Ne}.

### B. Fidelity

The memory fidelity [symbol] can be described by the operational fidelity [symbol] ₀ and measurement fidelity [symbol] ₘ via [symbol] = [symbol] ₀× [symbol] ₘ. Here, [symbol] 0 refers to the degradation of the quantum state as the probe field travels through the quantum memory device without storage, and the measurement fidelity [symbol] ₘ reflects how a finite signal-to-noise ratio (SNR) affects the quantum state measurement. In the case of the quantum memory described herein, [symbol] ₀ is an engineering effort and can be made close to unity. Thus, [symbol] ₘ is a main focus and is directly related to the SNR via

$${ℱ}_{𝓂} = 1 - \frac{1}{2 ( 1 + SNR )}$$

for a single incoming photon.

The SNR signal is directly related to storage efficiency η, while noise is related to the strong control field, Ω_{c}. Noise photons caused by Ω_{c} are due to two distinct origins. The first origin is due to Ω_{c} not involving any atomic transitions of the atomic vapor, and this noise can be measured when the atomic vapor is removed from the optical path. This first noise is called “technical noise.”

Technical noise is composed of the strong, narrowband Ω_{c} photons and weak, broadband photons due to the processes of generating and delivering the control light. In the quantum memories described herein, Ω_{c} is generated by a diode laser exhibiting broadband amplified spontaneous emission (ASE) noise and delivered via optical fibers in which Raman scattering occurs. In principle, technical noise can be eliminated without compromising the memory performance.

The second origin of noise is due to the interaction between Ω_{c} and the atoms of the atomic vapor, and this noise is defined as the excess noise photons when the atomic vapor is present in the optical path. This is “atomic noise.” In the systems described herein, atomic noise may be attributed to two atomic processes: spontaneous Raman scattering (SRS) and four-wave mixing (FWM). Here, the SRS is due to control field scattering of atoms in the F=2 state. FWM occurs as two consecutive, phase-matched-enhanced SRS due to the F=1 population and is enhanced by the optical depth (OD) and control field strength. The majority of atomic noise cannot be easily filtered as it has the same frequency as the f, field.

To reduce or eliminate both types of noise, a selection rule may be leveraged by preparing both the Ω_{c} and Ωₚ fields with orthogonal circular polarization, with a near-resonant Ω_{c} field to provide effective optical pumping. As a result, a lower noise rate may be observed compared with a linear polarization scheme under similar conditions.

### C. Storage Efficiency, η

For a given EIT-system, there exists an optimal solution of the photon shape that maximizes the storage efficiency. This ηₘₐₓ depends on the optical depth (OD) of the atomic medium, due to collective enhancement. In a warm-vapor system, the OD can be adjusted by changing the atomic vapor temperature.

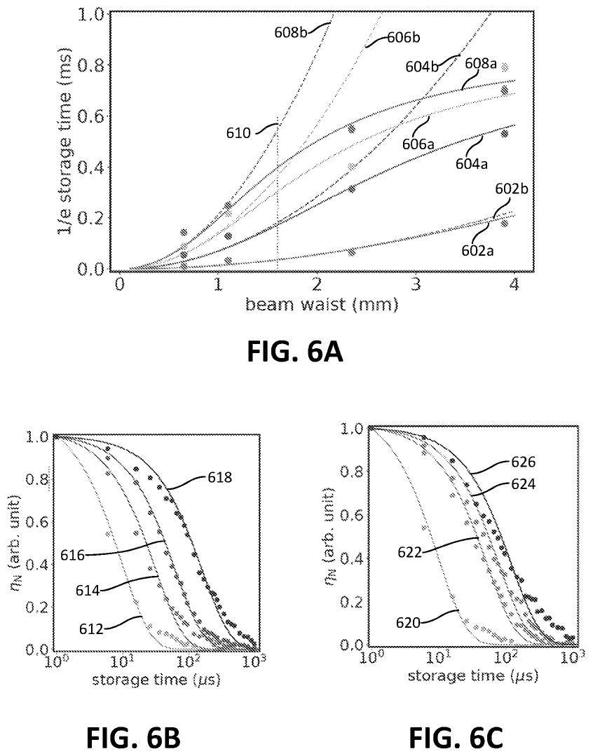

FIG. 7 shows plots of the storage efficiency, η, noise, signal-to-noise ratio (SNR), and OD as a function of atomic vapor temperature, in accordance with some embodiments of the technology described herein. In the upper panel the storage efficiency, η, is plotted as circles 702, referencing the left vertical axis. The noise is plotted as open squares 704, referencing the right vertical axis. In the lower panel, the corresponding SNR is plotted as circles 706, which are normalized to single-photon input and reference the left vertical axis. The measured OD is plotted as line 708 and references the right vertical axis. The storage efficiency, η, the noise, the SNR, and the OD were measured under different vapor temperatures with fixed control power of 20 mW. The input probe pulse contained n̅=2.74(1) photons. Error bars represent one standard deviations in all plots.

For each increasing atomic vapor temperature and corresponding increasing OD, an iterative approach is used to find an input photon shape that provides maximum efficiency. At low OD, the efficiency increases monotonically. However, at high OD, the efficiency decreases, which is attributed to the increased dephasing (e.g., density-dependent atom relaxation) and increased absorption. The highest efficiency reaches 7.0(2)%, which is limited by the destructive interference between two hyperfine excited levels (F=1,2).

### D. Signal-to-Noise Ratio (SNR)

The finite signal-to-noise-ratio (SNR) of the memory is a limiting factor in warm atomic vapor quantum memories, and the finite SNR effects a memory's fidelity.

Assuming a noise term of the form:

$${\hat{ρ}}_{n} = \frac{1}{2} ( \vert H 〉 〈 H \vert + \vert V 〉 〈 V \vert ) ,$$

and that the signal, or input photon, |ψ [symbol] =α|H [symbol] +β|V [symbol] , is a pure state

ρₛ|ψ [symbol] [symbol] ψ|,

then the density matrix upon retrieval of the photon from the memory would have the form:

$$\hat{ρ} = A {\hat{ρ}}_{s} + β {\hat{ρ}}_{n}$$

where A+B=1, and A/B=SNR. This means

$$A = \frac{S N R}{1 + S N R} , and B = \frac{1}{1 + S N R} .$$

The fidelity of the density matrix post-memory due to the SNR is then given by:

$$\begin{matrix}ℱ = {( T r \sqrt{\sqrt{\hat{{ρ}_{s}}} \hat{p} \sqrt{\hat{{ρ}_{s}}}} )}^{2} \\ = 1 - \frac{1}{2 ( 1 + S N R )}\end{matrix}$$

### E. Parameter Optimization

The quantum memories described herein may be systematically optimized in the η, T, [symbol] space. The first parameter to consider is the buffer gas pressure, which affects both T and η. As shown in FIGS. 6A-6C herein, increasing the buffer gas pressure significantly improves the storage time, T, by suppressing diffusion of atoms of the atomic vapor. However, the collision with buffer gas atoms also broadens the transitions to the hyperfine states, which induces stronger destructive interference. This results in a lower storage time, T.

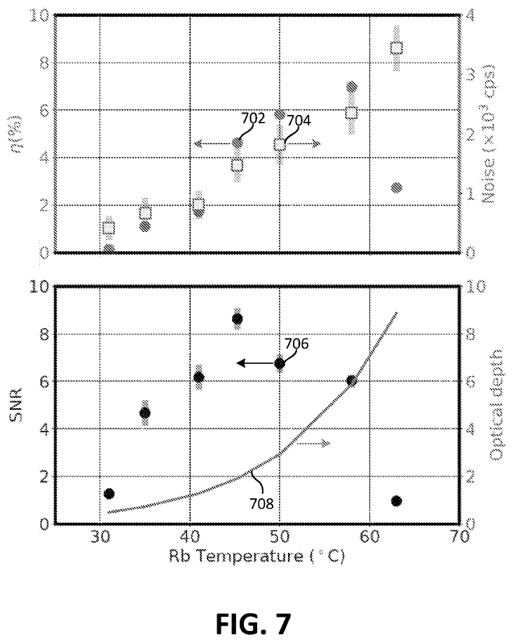

FIG. 8 is a plot of the storage efficiency, η, and storage time, T, as a function of buffer gas pressure and measured using a w=1.1 mm probe beam, in accordance with some embodiments of the technology described herein. The storage efficiency, η, is represented by circles 802, referencing the left vertical axis, and the storage time, T, is represented by squares 804, referencing the right vertical axis. For each buffer gas pressure, experimental conditions (e.g., OD and pulse shaping) were optimized to find the maximum storage efficiency. Note that since η is measured at t=5 μs rather than at t=0, its measurement is underestimated for low P_{Ne} conditions. The error bars are one standard deviations.

A buffer gas pressure of P_{Ne}=10 Torr achieves a sufficient balance between T and η. Depending on a user's specific application (e.g., short link length and detection efficiency) one can choose the buffer gas pressure to maximize the overall performance (e.g., providing higher efficiency but lower storage time).

The next parameters to consider are [symbol] and η. The use of light having orthogonal circular polarization greatly suppresses the atomic noise by the selection rule. However, it also limits the maximum achievable η due to the destructive interference between two hyperfine excited levels (F=1,2).

An improved SNR has been observed at the cost of a capped efficiency. One alternative is to use same circular polarization for both light fields, transforming the hyperfine level interference from destructive to constructive, resulting in a high (>40%) efficiency. However, in the parallel polarization scheme used, FWM is no longer turned off by the selection rule, causing more atomic noise. Moreover, the lack of polarization filtering mechanism (up to 50 dB) makes it technically costly to remove the strong control field itself. Consequently, it is challenging to achieve high fidelity with this scheme.

### F. Bandwidth

One benefit of EIT-based quantum memories is their ability to store photons of varying bandwidths to support a user's applications. These variable bandwidths are realized by adjusting the EIT window with the control field power, which affects the accepted spectral components of the atomic vapor.

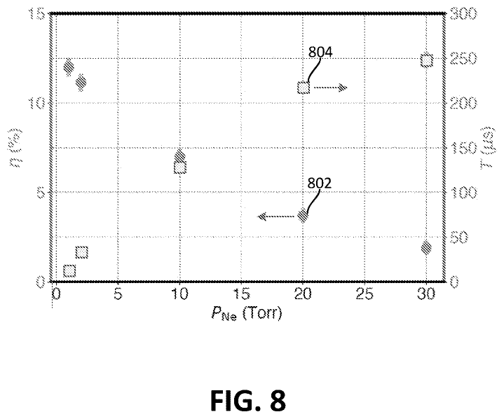

FIGS. 9A, 9B, and 9C show this effect. FIG. 9A is a plot of the normalized transmission of a probe field (5 μW) for different control field powers and as a function of two-photon detuning, δ, in accordance with some embodiments of the technology described herein. FIG. 9B is a plot of temporal profiles (i.e., bandwidths) of photons retrieved from the quantum memory using different control field powers, in accordance with some embodiments of the technology described herein. Traces for both figures are offset vertically. FIGS. 9A and 9B show that the EIT window and the photon bandwidth increase in size with increasing control field power.

FIG. 9C is a plot of the full width at half maximum (FWHM) of the electromagnetic induced transparency (EIT) and the FWHM of a spectral peak of the retrieved photon as a function of control field power, in accordance with some embodiments of the technology described herein. Line 902 is a functional fit to the measured FWHM of the EIT based on theory, and line 904 is a functional fit to the measured FWHM of the spectral peak of the retrieved photon based on theory. The experimental data uncertainty is smaller than the data symbols.

The linear increase of 0.128(1) MHz/mW in the EIT window width as shown in FIG. 9C is well explained theoretically as being in the “power-linear” regime. Similarly, the optimal photon bandwidth is expected to increase linearly with control field power. However, the control field, fc, was not able to be turned off sufficiently fast in practice, resulting in the sub-linear dependence shown in line 904 of FIG. 9C, which is explained by an ad-hoc theory taking this experimental limitation into account.

The control field is intensity-modulated by a free space acoustic-optical-modulator (AOM) with a rise time of 100-ns, which is comparable to the pulse duration. This finite rise time creates an effective Ω_{c} that is lower than its peak value, reducing the storage efficiency of high-frequency spectral components. This behavior is modeled by numerically integrating the optical Bloch equation, shown as line 904, which provides agreement with the experimental data. Faster switching may be achieved (e.g., using an EOM), and the retrieved photon linewidth at high control field power should increase to overlap with the EIT window. Importantly, it is noted that changing the photon bandwidth does not affect other memory performance such as η, T, and [symbol] .

### V. Filter Module

As described in connection with FIG. 1 herein, the device housing 100 may include a filter module 120 arranged to filter an output of the quantum memory module 110. The inventors recognized and appreciated that achieving high measurement fidelity, [symbol] , is more easily achieved by implementing efficient filtering of excessive noise photons from an output of the quantum memory. In particular, [symbol] may be improved by filtering the technical noise due to a strong control field, Ω_{c}. There exist three types of technical noise photons: the control field Ω_{c}, which are on the order of 10¹⁰ photons per pulse; the fiber Raman scattering of Ω_{c}; and the ASE noise from diode lasers. In the quantum memory module 110, polarization elements are used to combine and separate Ω_{c} and Ωₚ with a suppression of ≥50 dB. The remaining technical noise is further filtered spectrally using the additional filter module 120.

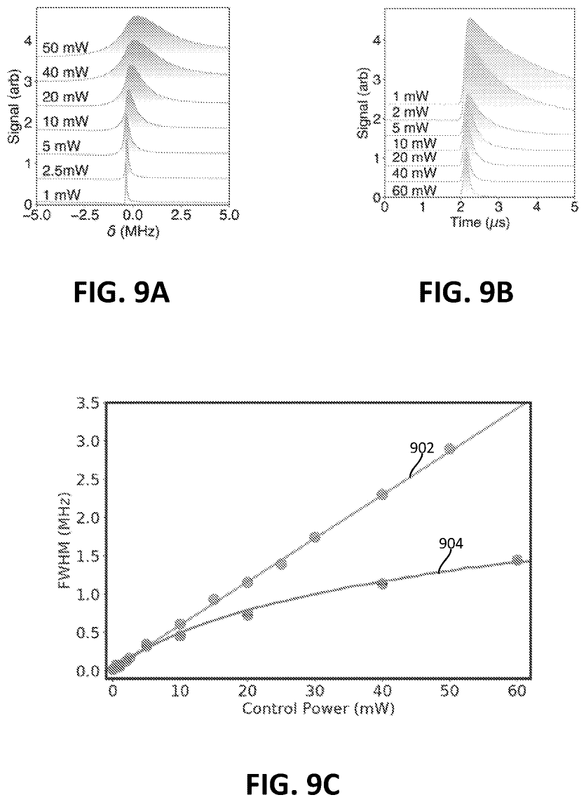

FIG. 10 is a schematic diagram of a filter module 1000, in accordance with some embodiments of the technology described herein. The filter module 1000 may be implemented in, for example, filter module 120 described in connection with FIG. 1, in some embodiments.

In some embodiments, the filter module 1000 includes an input port 1002 that is configured to receive an output from a quantum memory module (e.g., quantum memory module 110). The received output may contain control field photons and probe photons.

In some embodiments, the received input may be filtered using a first Fabry-Pérot cavity 1006a and a second Fabry-Pérot cavity 1006b coupled between the input port 1002 and the output port 1014 of the filter module 1000. The Fabry-Pérot cavities 1006a and 1006b may each be monolithic, 0.5-inch diameter, plano-convex high-finesse Fabry-Pérot etalons with incommensurate free spectral ranges (FSR). The Fabry-Pérot cavities 1006a and 1006b may be thermally tuned to be resonant with the Ωₚ field, having a coefficient of −2.4 MHz/mK.

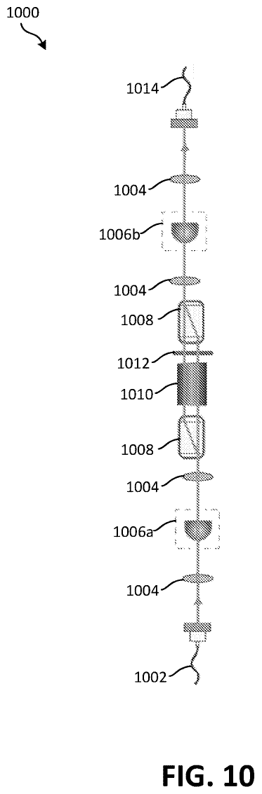

This combination of high finesse (200˜300) and FSR (13 GHz and 21 GHz) provides greater than 80 dB of suppression of the control field photon and greater than 40 dB of suppression of the broadband noise. The corresponding linewidths are 2π×40 MHz and 2π×100 MHz, respectively. With proper mode matching practice greater than 80% transmission for single cavity, and greater than 50% transmission through the filter module 1000, can be achieved. Additional details of the Fabry-Pérot cavities 1006a and 1006b are described in connection with FIGS. 11A-11C herein.

In some embodiments, a polarization-agnostic optical isolator may be coupled between the two Fabry-Pérot cavities 1006a and 1006b to prevent back reflections from the second Fabry-Pérot cavity 1006b. The optical isolator includes two beam displacers 1008. The beam displacers 1008 may be calcite beam displacers, in some embodiments. The beam displacers 1008 may be separated by a distance of approximately 2.7 mm.

In some embodiments, the two beam displacers 1008 may be optically coupled through a Faraday rotator 1010 and a half waveplate 1012. The combined beam displacers 1008, Faraday rotator 1010, and half waveplate provide greater than 40 dB rejection for light propagating backwards from the second Fabry-Pérot cavity 1006b.

In some embodiments, a number of lenses 1004 may be included in the filter module 1000. the lenses 1004 may be configured to focus and/or control a beam size of the light traveling along the optical path between the input port 1002 and the output port 1014.

In some embodiments, a temperature of the Fabry-Pérot cavities 1006a and 1006b may be actively stabilized using a feedback servo having ˜1 mK resolution and by heating the housings of the Fabry-Pérot cavities 1006a and 1006b. The Fabry-Pérot cavities 1006a and 1006b are highly sensitive to temperature, as their properties are tuned by changing their temperature (causing a length change). A stable temperature of the Fabry-Pérot cavities 1006a and 1006b significantly improves performance of the filter module in rejecting noise and transmitting qubits. Such temperature stability can be achieved with good thermal isolation, such as conventional vacuum techniques. However, the inventors have developed cavity housings that meet low-SWaP requirements and achieve high thermal insensitivity in a vacuum-free, small footprint system, providing high mechanical reliability (e.g., maintaining a center of the etalons on the optical axis) and accuracy (e.g., maintaining the etalon temperature within 0.001° C.).

FIG. 11A is an illustration of an isometric view of a Fabry-Pérot cavity 1100, and FIGS. 11B and 11C are illustrations of cross-sectional views of the Fabry-Pérot cavity 1100, in accordance with some embodiments of the technology described herein. The Fabry-Pérot cavity 1100 includes an external housing 1110, an internal housing 1120 disposed within the external housing 1110, a lens tube 1130 disposed within the internal housing 1120, and an etalon 1140 secured within the lens tube 1130.

The geometry of the components of the Fabry-Pérot cavity 1100 and choice of materials enables the external housing 1110, the internal housing 1120, and the lens tube 1130 to, in response to a change in temperature, uniformly deform in a direction perpendicular to an optical axis of the Fabry-Pérot cavity and to maintain a position of a center of the etalon 1140 on approximately the optical axis. Additionally, the symmetry of the components of the Fabry-Pérot cavity 1100 causes the cavity 1100 to be self-aligning and/or self-centering when the external temperature changes due to the symmetric geometry of the mounting.

In some embodiments, each of the external housing 1110, the internal housing 1120, and the lens tube 1130 comprise unibody parts with no gaps, screws, or multiple materials. The use of unibody parts minimizes potential thermal gradients arising from material interfaces. Minimizing contact points between each of the external housing 1110, the internal housing 1120, and the lens tube 1130 further reduces thermal contacts within the Fabry-Pérot cavity 1100.

In some embodiments, the external housing 1110 is formed of a material having a low thermal expansion coefficient and a low thermal conductivity. These material properties ensure that the external housing 1110 remains securely bolted to the base plate supporting the filter module 1000 but that the external housing 1110 is not in good thermal contact with the base plate. This reduces crosstalk between heated or temperature-controlled elements, as well as between the base plate and the etalon 1140.

In some embodiments, the external housing comprises a material having a thermal expansion coefficient in a range from 5×10−6 K⁻¹ to 20×10−6 K⁻¹ at room temperature and a thermal conductivity in a range from 10 W/m·K to 20 W/m·K at room temperature (e.g., in a range from 18° C. to 25° C.). In some embodiments, the external housing 1110 is formed of hard-tempered stainless steel 316L.

In some embodiments, the external housing 1110 may be manufactured using additive manufacturing techniques. For example, the external housing 1110 may be manufactured using a Binder Jet method and finished with a Zirblast finishing. The use of additive manufacturing allows for a complex geometry of the external housing 1110 that is optimized for best mounting, minimal mass, and maximum strength of the external housing 1110.

In some embodiments, multiple mounting options of the external housing 1110 are possible. For example, in some embodiments the external housing 1110 includes bolt mounting 1112 and nut mounting 1114. The bolt mounting 1112 may allow for mounting the external housing 1110 from a top-down direction. In contrast, the nut mounting 1114 may allow for mounting the external housing 1110 from below the external housing 1110.

In some embodiments, the external housing 1110 further includes mounting surface vent channels 1116. The mounting surface vent channels 1116 may minimize physical and thermal contact between the external housing 1110 and the base plate that the external housing 1110 is mounted to. Additionally, the mounting surface vent channels 1116 may allow for thermal dissipation along the vent channels 1116.

In some embodiments, the external housing 1110 may include iris ring mounts 1113 and 1115. The iris ring mounts 1113 and 1115 may be disposed at a forward and rearward (along the optical axis) ends of the external housing 1110. Opening apertures can be reduced on either side by mounting an iris, or other aperture element, onto the iris ring mounts 1113 and 1115.

In some embodiments, the internal housing 1120 may be disposed within the external housing 1110. The internal housing 1120 may be press-fit within the external housing 1110 but may have minimal thermal contact points to the external housing 1110 (e.g., having only two rings on either end of the internal housing 1120 in contact with the external housing 1110).

In some embodiments, the internal housing 1120 may be formed of a material having a relatively high thermal conductivity and a low coefficient of thermal expansion. The high thermal conductivity allows for precise and fast temperature tuning of the internal housing 1120, while the low thermal expansion coefficient prevents alignment changes of the etalon 1140. In some embodiments, the internal housing may be formed of a material having a thermal expansion coefficient in a range from 10×10−6 K⁻¹ to 30×10−6 K⁻¹ at room temperature and a thermal conductivity in a range from 120 W/m·K to 150 W/m·K at room temperature (e.g., in a range from 18° C. to 25° C.). In some embodiments, the internal housing 1120 may be formed of anodized aluminum 7075-T7 or anodized aluminum 7075-T8.

In some embodiments, an air gap 1121 may be disposed between an outer surface of the internal housing 1120 and an interior surface of the external housing 1110. In some embodiments, aerogel insulation 1126 may be disposed within the air gap 1121. In some embodiments, aerogel insulation 1126 and a resistive heater foil 1127 may be disposed within the air gap 1121. The resistive heater foil 1127 may make thermal contact with the internal housing 1120 and the aerogel insulation 1126 may be positioned between the resistive heater foil 1127 and the external housing 1110. In some embodiments, the air gap 1121 may be left empty.

In some embodiments, the Fabry-Pérot cavity 1100 may include a ceramic resistive ring heater 1126. The ceramic resistive ring heater 1126 may be mounted adjacent an end of the internal housing 1120.

In some embodiments, the internal housing 1120 may include a threaded hole 1122. The threaded hole 1122 may be configured to accept a set screw configured to lock the lens tube 1130 in place after assembling the lens tube within the internal housing 1120.

In some embodiments, the internal housing 1120 may include a hole 1124 configured to house a thermistor. The thermistor may be configured to monitor a temperature of the Fabry-Pérot cavity 1100. In some embodiments, the thermistor may be a negative temperature coefficient (NTC) thermistor.

In some embodiments, the thermistor may be coupled to a precision PID controller (“proportional-integral-derivative” controller). The PID controller may control a low-noise current that is configured to maintain a temperature setpoint within the Fabry-Pérot cavity 1100. In some embodiments, an external secondary environmental monitoring thermistor (not pictured) can be used to further apply a compensation feedback servo in order to compensate for slower long-term temperature drifts.

In some embodiments, the lens tube 1130 may be press-fit inside the internal housing 1120. In some embodiments, lens tube 1130 may be formed of a material having a relatively high thermal conductivity and a low coefficient of thermal expansion. The high thermal conductivity allows for precise and fast temperature tuning of the lens tube 1130, while the low thermal expansion coefficient prevents alignment changes of the etalon 1140. In some embodiments, the internal housing may be formed of a material having a thermal expansion coefficient in a range from 10×10−6 K⁻¹ to 30×10−6 K⁻¹ at room temperature and a thermal conductivity in a range from 120 W/m·K to 150 W/m·K at room temperature (e.g., in a range from 18° C. to 25° C.). In some embodiments, the lens tube 1130 may be formed of anodized aluminum 7075-T7 or anodized aluminum 7075-T8.

In some embodiments, the etalon 1140 may be retained within the lens tube 1130. For example, the etalon 1140 may be retained within the lens tube 1130 using rings 1142a and 1142b. The rings 1142a and 1142b may be a combination stack of a first thin polished brass ring having a first thickness and a second larger polished brass ring having a second thickness greater than the first thickness. For example, the first ring (e.g., ring 1142a) may have a thickness of 2-3 mm while the second ring (e.g., ring 1142b) may have a thickness of 3-5 mm. The use of the two rings 1142a and 1142b to secure the etalon 1140 may prevent the application of pressure on the etalon 1140.

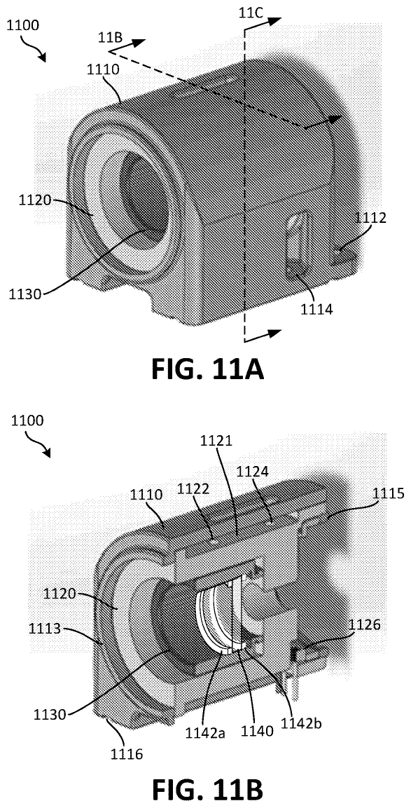

FIG. 12 shows plots describing thermal stability of an etalon in a Fabry-Pérot cavity (e.g., Fabry-Pérot cavity 1100) as a function of time, in accordance with some embodiments of the technology described herein. The top plot is measured cavity transmission as a function of time, and the bottom plot is measured temperature changes of the room in which the Fabry-Pérot cavity was situated. The room temperature shows fast HVAC fluctuations and slow drifts. As shown by the top plot, the Fabry-Pérot cavity is generally robust against rapid temperature changes, with transmission remaining stable over multiple hours, with a mean cavity transmission of 73.1% and a standard deviation of 1.4%.

The Fabry-Pérot cavity describe herein exhibits high isolation factor of 58 and a long relaxation time of 63 minutes, effectively creating a strong low-pass filter, making the etalon system immune to rapid environmental temperature changes. Considering common HVAC regulated environments (e.g., a fiber hub) typically exhibit <1 K change on a 10 to 20-minute time scale, the Fabry-Pérot cavity described herein can reliably maintain high transmission and stay on resonance for many hours without user intervention, making the Fabry-Pérot cavity field-deployable.

### V. Measured Performance

### A. Fidelity

Geared towards field deployment, the quantum memory described herein ideally exhibits robust performance against environmental changes over many hours. Here, measurements of the operation fidelity, [symbol] , for the quantum memory module and filter module are presented.

A factor which can affect the fidelity of the memory is the differing transmission of the two rails. To quantify this effect consider an arbitrary state:

$$\vert ψ 〉 = α \vert H 〉 + β \vert V 〉 ,$$

where α and β are complex numbers normalized such that |α|²+|β|²=1.

Assume that one polarization experiences perfect transmission, while the other is imperfect with a real coefficient 0≤t≤1, resulting in a state:

$$\vert ψ 〉 = \frac{1}{\sqrt{{α}^{2} + {β}^{2} {t}^{2}}} ( α \vert H 〉 + β t \vert V 〉 ,$$

where re-normalization has been performed to account for the loss in the |V [symbol] , mode. The fidelity, given the loss, is then:

$$\begin{matrix}F = \vert 〈 ψ \vert {ψ}^{′} 〉 {\vert}^{2} \\ = \frac{{( 1 + ℬ ( t - 1 ) )}^{2}}{1 + ℬ ( {t}^{2} - 1 )} ,\end{matrix}$$

where the fact that |α|²+|β|²=1 has been used to eliminate α and to set [symbol] =|β|². Differentiating this to find the extrema yields:

$$\frac{\partial F}{\partial ℬ} = 0 \to ℬ = \frac{1}{1 + t} , \frac{1}{1 - t} .$$

The second solution is unphysical, while the first solution corresponds to the state for which the fidelity is a minimum, thus:

$${F}_{transmission} \geq \frac{4 \sqrt{T}}{{( 1 + \sqrt{T} )}^{2}} ,$$

where T=t² is the transmission for the imperfectly transmitted rail.

Because the quantum memory stores arbitrary polarization qubits using two spatial rails within the atomic vapor, [symbol] is related to the mechanisms affecting the transmission of two rails, which can be broken into the amplitude and phase. The fidelity loss due to differential transmission depends on the input state. Therefore, the “worst case” scenario is considered, in which a specific input state results in the lowest fidelity. The amplitude can be measured directly, where T is defined as the transmission ratio between two rails (0≤T≤1). An analytical solution of fidelity in the worst-case has the form:

$${ℱ}_{0} = \frac{4 \sqrt{T}}{{( 1 + \sqrt{T} )}^{2}}$$

To access the phase, the input state is adjusted to be an equal superposition of two modes, and the output polarization state is measured using a polarimeter. The parameters of the polarization ellipse, ellipticity and azimuth angle, are used to calculate this differential phase.

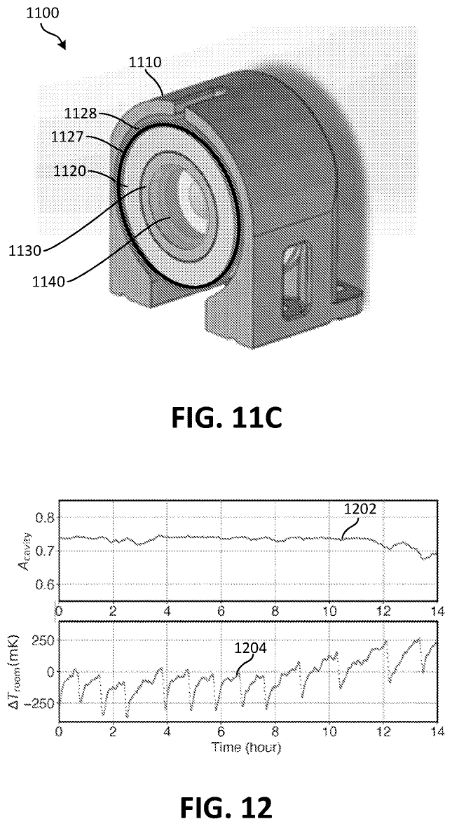

FIG. 13A is a plot of the measured operation error due to amplitude as a function of time, and FIG. 13B is a plot of measured operation error due to phase as a function of time, in accordance with some embodiments of the technology described herein. The operation error is defined as 1− [symbol] and was measured on a day scale under typical experimental conditions, including less than 4 K of environmental temperature changes, 20-30% humidity, and with the quantum memory module and filter module being rack-mounted in a rack tower. The operation error was measured for the filter module (data 1302 and data 1306) and the quantum memory module (data 1304 and data 1308).

These operation errors remain remarkably low and are less than 0.002 for the quantum memory module and less than 0.02 for the filter module, both over many hours. The errors are caused by the transmission performances between rails. In the quantum memory module, the dominant source of operation error is due to the creation and recombination of two widely-separated and large-waist rails. In the filter module, the operation error is mostly caused by the birefringence of the etalon optics.

B. [symbol] , η, and T

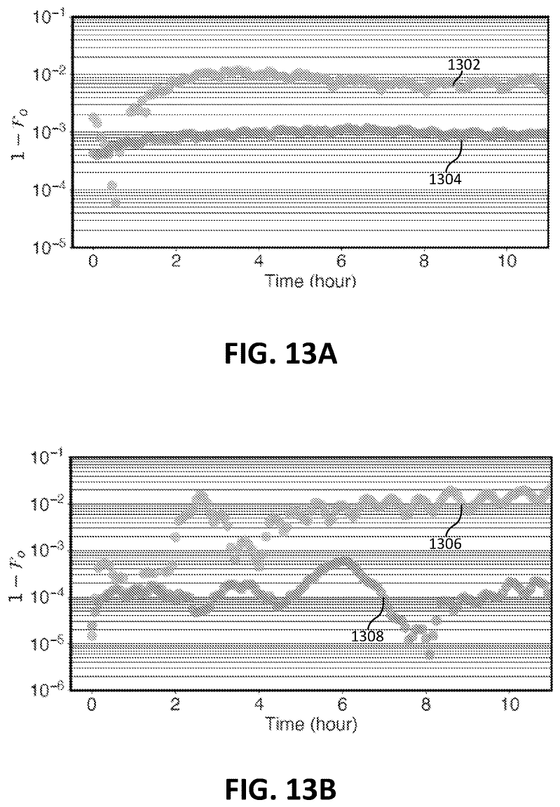

FIG. 14 is a plot illustrating the storage and retrieval of photons from a combined quantum memory and filter device, in accordance with some embodiments of the technology described herein. The memory operation of FIG. 14 includes an input pulse 1402 with an arbitrary polarization containing n̅=2.74(1) photons and a retrieved pulse 1404 (scaled by a factor of 20). The input pulse 1403 has a FWHM duration of 218(1) ns and a bandwidth of 2π×0.770(2) MHz, and the Rb vapor has a temperature of 45° C. with an experimentally measured OD of 2.0(1).

To evaluate the SNR, a 200 ns detection window is chosen for analyzing the retrieved signal. A larger, 1 ms window taken after the photon retrieval and while Ω_{c} remains on is used to determine the noise rate with better photon statistics, which is consistent with the measured noise under the detection window when the input pulse is blocked, where the unconditional noise floor is 1.9(1)×10⁻³ photons per storage trial. The SNR is then calculated and scaled to obtain the SNR for an input of exactly one photon.

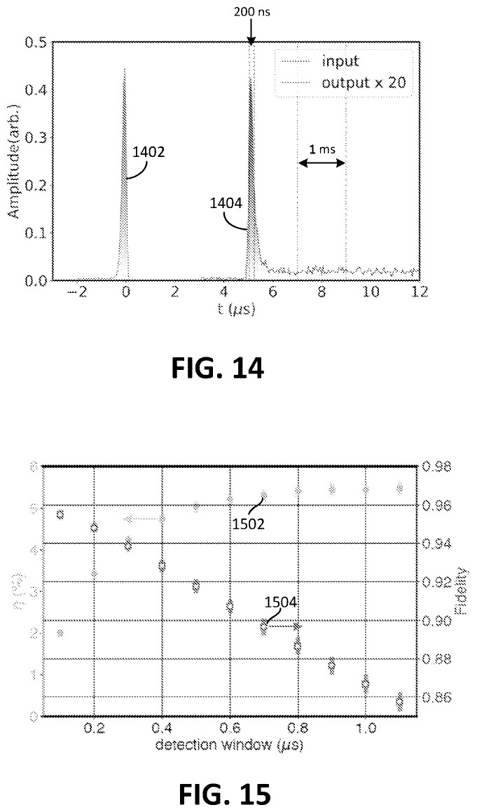

The choice of the detection window size is a trade-off between the number of successful events and read-out fidelity. FIG. 15 is a plot showing the dependence of efficiency and fidelity on the width of the detection window. The efficiency is represented by data points 1502, referencing the left vertical axis, and the fidelity is represented by data points 1504, referencing the right vertical axis. Depending on the details of the applications (e.g., link length, bandwidth mismatch, detector efficiency/dark count, etc.), the user can choose a suitable window size to optimize specific functions. Using a 200 ns window that is matched to the input pulse size, the SNR is measured to be SNR_{n̅=1}=8.63(44) under polarization-agnostic operation.

The corresponding measurement fidelity is [symbol] =94.8(2)%. For applications with known input photon polarization state, higher SNR and fidelity can be straightforwardly obtained by using only one rail, leading to SNR_{n̅=1}=17.3. For a generous window size that encloses the entire pulse, the quantum memory described herein offers greater than 5% efficiency at [symbol] >0.9.

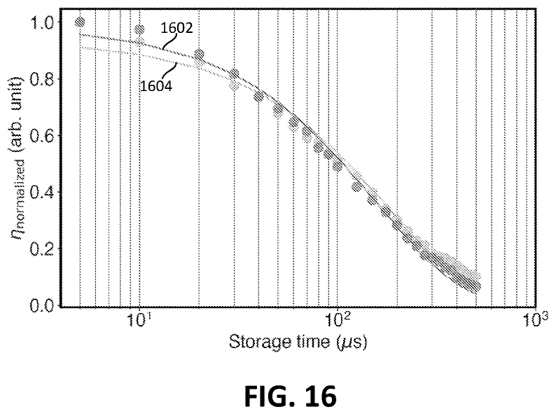

The storage time, T, was also measured. FIG. 16 is a plot of normalized storage efficiency as a function of storage time for two rails of the quantum memory, in accordance with some embodiments of the technology described herein. The lines 1602 and 1604 represent exponential fits to the right rail and left rail, respectively. The right rail and the left rail were measured to have 1/e decay constants of 157(4) μs and 180(6) μs, respectively. Both rails exhibit T>150 μs.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Having thus described several aspects and embodiments of the technology set forth in the disclosure, it is to be appreciated that various alterations, modifications, and improvements will readily occur to those skilled in the art. Such alterations, modifications, and improvements are intended to be within the spirit and scope of the technology described herein. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein. Those skilled in the art will recognize or be able to ascertain using no more than routine experimentation many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The use of “coupled” or “connected” is meant to refer to elements, or signals, that are either directly linked to one another or are linked through intermediate components. Elements that are not “coupled” or “connected” are “decoupled” or “disconnected.”

The use of “between” in a coupled signal chain is not meant to require a particular direction of signal flow in the signal chain unless stated otherwise. For instance, where element B is described as coupled between elements A and C in a signal chain, signals may flow from element A to element C through element B and/or from element C to element A through element B unless stated otherwise.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

The terms “approximately” and “about” may be used to mean within ±20% of a target value in some embodiments, within ±10% of a target value in some embodiments, within ±5% of a target value in some embodiments, within ±2% of a target value in some embodiments. The terms “approximately” and “about” may include the target value.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

1. A quantum memory device, comprising:
a housing; and
a quantum memory module disposed in the housing and configured to store an input qubit, wherein:
the housing is configured to be rack-mounted.

2. The quantum memory device of claim 1, wherein the housing is configured to be rack-mounted in a server rack.

3-4. (canceled)

5. The quantum memory device of claim 1, wherein:
the housing comprises a first base plate and a second base plate, the first base plate and/or the second base plate configured to movably slide in a direction perpendicular to a front face of the housing,
the quantum memory module is disposed on the first base plate,
a filter module is disposed on the second base plate, and
the filter module is optically coupled to an output of the quantum memory module.

6. (canceled)

7. The quantum memory device of claim 5, wherein the first base plate and/or the second base plate are mechanically decoupled from the housing.

8. The quantum memory device of claim 7, wherein the first base plate and/or the second base plate are suspended within the housing.

9. The quantum memory device of claim 1, wherein:
the quantum memory module comprises an atomic vapor memory optically coupled to an input of the quantum memory module,
the atomic vapor memory comprises an atomic vapor cell, and
the atomic vapor memory is configured to store the input qubit in an atomic vapor of the atomic vapor cell.

10-12. (canceled)

13. The quantum memory device of claim 9, wherein the atomic vapor memory comprises at least one heater, the at least one heater comprising:
a bifilar resistive wire wound in a toroidal arrangement configured to generate approximately zero magnetic field at a center of the at least one heater.

14. The quantum memory device of claim 13, wherein the bifilar resistive wire is wound around a base ring comprising a high-temperature plastic or a ceramic.

15-16. (canceled)

17. The quantum memory device of claim 13, wherein the quantum memory module further comprises a magnetic shielding apparatus, the magnetic shielding apparatus being arranged to at least partially encapsulate the atomic vapor cell of the atomic vapor memory.

18. The quantum memory device of claim 17, wherein the magnetic shielding apparatus comprises:
a first magnetic shielding layer arranged to at least partially encapsulate the atomic vapor cell; and
a second magnetic shielding layer arranged to at least partially encapsulate the second magnetic shielding layer.

19. The quantum memory device of claim 18, wherein:
the atomic vapor cell, the first magnetic shielding layer, and the second magnetic shielding layer are each approximately cylindrical in shape, and
the atomic vapor cell, the first magnetic shielding layer, and the second magnetic shielding layer are arranged concentrically about a same longitudinal axis.

20. The quantum memory device of claim 19, wherein:
the at least one heater comprises a first heater and a second heater,
the first heater is disposed at a first end of the atomic vapor cell,
the second heater is disposed at a second end of the atomic vapor cell opposing the first end, and
base rings of the first and second heaters are disposed in planes perpendicular to the longitudinal axis.

21. The quantum memory device of claim 19, wherein the magnetic shielding apparatus comprises an outer shell, the outer shell comprising:
a first shell, the first shell comprising:
a lower face;
four side faces extending from the lower face; and
an opening opposing the lower face, wherein:
the first magnetic shielding layer is disposed within the first shell; and
a second shell comprising:
an upper face disposed over the opening in the first shell; and
two side faces extending from the upper face and substantially covering two of the four side faces of the first shell.

22. The quantum memory device of claim 21, wherein the first shell comprises a first material and the second shell comprises a second material different than the first material.

23. The quantum memory device of claim 22, wherein the first material comprises Ad-Mu-00 magnetic shielding alloy and/or the second material comprises aluminum 6061.

24. (canceled)

25. The quantum memory device of claim 21, wherein two of the four side faces of the first shell that are not substantially covered by the two side faces of the second shell each comprise an optical window disposed along the longitudinal axis.

26. The quantum memory device of claim 21, wherein the second shell further comprises hold down features coupled to each of the two side faces of the second shell.

27-29. (canceled)

30. The quantum memory device of claim 5, wherein the filter module comprises:
a first Fabry-Pérot cavity optically coupled to an input of the filter module;
a Faraday rotator optically coupled to an output of the first Fabry-Pérot cavity; and
a second Fabry-Pérot cavity optically coupled to an output of the Faraday rotator.

31. The quantum memory device of claim 30, wherein the filter module further comprises:
a first beam displacer disposed along an optical path of the filter module between the first Fabry-Pérot cavity and the Faraday rotator; and
a second beam displacer disposed along the optical path between the Faraday rotator and the second Fabry-Pérot cavity.

32. The quantum memory device of claim 31, wherein the first Fabry-Pérot cavity comprises:
an external housing;
an internal housing disposed within the external housing;
a lens tube disposed within the internal housing; and
an etalon disposed within the lens tube.

33. The quantum memory device of claim 32, wherein the external housing comprises a material having a thermal expansion coefficient in a range from 5×10⁻⁶ K⁻¹ to 20×10⁻⁶ K⁻¹ at room temperature and a thermal conductivity in a range from 10 W/m·K to 20 W/m·K at room temperature.

34-35. (canceled)

36. The quantum memory device of claim 32, wherein the internal housing and/or the lens tube comprises a material having a thermal expansion coefficient in a range from 10×10⁻⁶ K⁻¹ to 30×10⁻⁶ K⁻¹ at room temperature and a thermal conductivity in a range from 120 W/m·K to 150 W/m·K at room temperature.

37-38. (canceled)

39. The quantum memory device of claim 32, wherein an air gap is disposed between an exterior surface of the internal housing and an interior surface of the external housing.

40. The quantum memory device of claim 39, wherein aerogel insulation and/or a resistive heater foil is disposed in the air gap.

41. (canceled)

42. The quantum memory device of claim 32, wherein the first Fabry-Pérot cavity further comprises a ceramic resistive heater disposed within the external housing and adjacent an end of the internal housing.

43-44. (canceled)

45. The quantum memory device of claim 32, wherein the first Fabry-Pérot cavity further comprises a thermistor embedded in the internal housing, the thermistor configured to monitor a temperature of the first Fabry-Pérot cavity.

46-84. (canceled)
